(19) United States
(12) Patent Application Publication
(10) Pub. No.: US 2026/0342393 A1
(43) Pub. Date: Oct. 29, 2026

(54) METHOD AND DEVICE FOR RECEIVING AND TRANSMITTING INFORMATION

(71) Applicant: Samsung Electronics Co., Ltd., Gyeonggi-do (KR)

(72) Inventors: Zhe CHEN, Beijing (CN); Feifei SUN, Beijing (CN); Bin YU, Beijing (CN)

(21) Appl. No.: 19/102,521

(22) PCT Filed: Aug. 2, 2023
(86) PCT No.: PCT/KR2023/011336

§ 371 Date: Feb. 10, 2025

(30) Foreign Application Priority Data
Aug. 10, 2022 (CN) 202210957945.7
Sep. 7, 2023 (CN) 202211089643.9

(51) Int. Cl. H04B 7/06

(52) U.S. Cl. CPC H04B 7/0626; H04B 7/063

(57) ABSTRACT

The disclosure is related to a 5G or 6G communication system for supporting a higher data transmission rate. The present application relates to the technical field of wireless communication and more particularly to providing effective methods and devices for receiving and transmitting information. The present disclosure can improve the performance of channel state information (CSI) measurement and/or CSI reporting.

### TECHNICAL FIELD

The present application relates to the technical field of wireless communication, and more particularly, to methods and devices for receiving and transmitting information.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

Transmission from a base station to a user equipment (UE) is called downlink, and transmission from a UE to a base station is called uplink.

### DISCLOSURE OF INVENTION

### Technical Problem

The purpose of the present disclosure provides effective methods and devices for receiving and transmitting information. The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

An aspect of the present disclosure provides a method performed by a terminal device in a communication system and the terminal device performing the method, the method comprising:
receiving channel state information (CSI) resource configuration information and first information, wherein the first information includes duplex information or network energy saving information; determining at least one of CSI resources, power parameters corresponding to the CSI resources, and spatial domain parameters corresponding to the CSI resources according to the CSI resource configuration information and the first information.

According to one aspect of the present disclosure, there is provided a method performed by a terminal device in a network, the method comprising: receiving channel state information (CSI) resource configuration information and first information, wherein the first information includes duplex information or network energy saving information; determining at least one of CSI resources, power parameters corresponding to the CSI resources, and spatial domain parameters corresponding to the CSI resources according to the CSI resource configuration information and the first information.

In an example, the CSI resource configuration information includes fourth frequency domain information, and the determining at least one of the CSI resources, the power parameters corresponding to the CSI resources, and the spatial domain parameters corresponding to the CSI resources according to the CSI resource configuration information and the first information comprises: determining the CSI resources according to at least one of third frequency domain resources corresponding to the first information and the fourth frequency domain information, and frequency domain information corresponding to BWP of the terminal device.

In an example, the power parameters corresponding to the CSI resources includes a first power parameter and a second power parameter, wherein the second power parameter is determined based on a first parameter and the first power parameter.

In an example, the first parameter is indicated by the base station or is predefined, and the first parameter includes a difference between the second power parameter and the first power parameter or a ratio of the second power parameter to the first power parameter.

In an example, the spatial domain parameters corresponding to the CSI resources includes a first spatial domain parameter and a second spatial domain parameter, wherein the second spatial domain parameter is determined based on a second parameter and the first spatial domain parameter.

In an example, the first parameter is indicated by the base station or is predefined, and the first parameter includes a port quantity ratio of the second spatial domain parameter to the first spatial domain parameter.

In an example, the method further includes: determining CSI feedback or reporting the CSI feedback according to at least one of the CSI resources, the power parameters corresponding to the CSI resources, and the spatial domain parameters corresponding to the CSI resources.

In an example, the network energy saving information includes at least one of: network state information; network mode information; network switch information.

According to one aspect of the present disclosure, there is provided a method performed by a terminal device in a network, the method comprising: receiving channel state information (CSI) resource configuration information, wherein the CSI resource configuration information includes first frequency domain information and second frequency domain information; determining frequency domain resources corresponding to CSI resources according to the first frequency domain information and/or the second frequency domain information.

In one example, the first frequency domain information includes an index of a first resource block (RB) and a number of the first RB, and the second frequency domain information includes an index of a second RB and a number of the second RB.

In an example, frequency domain resources corresponding to the first frequency domain information and frequency domain resources corresponding to the second frequency domain information do not overlap in frequency domain.

According to one aspect of the present disclosure, there is provided a method performed by a terminal device in a network, the method comprising: receiving indication information for indicating the terminal device to report channel state information (CSI) feedback; receiving first information, wherein the first information is duplex information or network energy saving information; reporting the CSI feedback or determining the CSI feedback according to CSI resources and the first information, based on the indication information.

In an example, the reporting the CSI feedback according to the CSI resources and the first information comprises at least one of: if the CSI resources are received in first time domain resources corresponding to the first information, reporting the CSI feedback; if the CSI resources are received in the first time domain resources not corresponding to the first information, reporting the CSI feedback; if, on the first time domain resources corresponding to the first information, the frequency domain resources corresponding to the CSI resources are greater than or equal to the value indicated by a base station or a predefined value, reporting the CSI feedback; if frequency domain resources of bandwidth parts (BWP) of the terminal device are included in third frequency domain resources corresponding to the first information, reporting the CSI feedback.

In an example, the determining the CSI feedback according to the CSI resources and the first information comprises at least one of: determining the CSI feedback according to the CSI resources and first time domain resources corresponding to the first information; determining the CSI feedback according to the CSI resources and third frequency domain resources corresponding to the first information; on CSI reference resources, determining the CSI feedback according to the CSI resources and the first information.

In an example, the determining the CSI feedback according to the CSI resources and the first time domain resources corresponding to the first information comprises at least one of: determining the CSI feedback according to the first time domain resources corresponding to the first information and/or CSI resources not in the first time domain resources corresponding to the first information; determining a first CSI feedback according to CSI resources in the first time domain resources corresponding to the first information, and determining a second CSI feedback according to the CSI resources not in the first time domain resources corresponding to the first information, wherein, the first CSI feedback and the second CSI feedback are included in the CSI feedback.

In an example, the determining the CSI feedback according to the CSI resources and the third frequency domain resources corresponding to the first information comprises at least one of: determining the CSI feedback according to BWP of the terminal device and/or the third frequency domain resources corresponding to the first information, wherein the determining the CSI feedback according to BWP of the terminal device and/or the third frequency domain resources corresponding to the first information includes: determining subband parameters corresponding to the CSI feedback according to the BWP of the terminal device and/or the third frequency domain resources corresponding to the first information, and wherein the subband parameters corresponding to the CSI feedback are determined by one of:
determining the subband parameters according to a BWPfrequency domain resources corresponding to BWP subtracted by the third frequency domain resources corresponding to the first information; determining the subband parameters according to the third frequency domain resources corresponding to the first information; determining the subband parameters according to frequency domain resources corresponding to the BWP.

In an example, the determining the CSI feedback according to the CSI resources and the third frequency domain resources corresponding to the first information comprises: determining a frequency domain granularity corresponding to the CSI feedback according to the BWP and/or the third frequency domain resources.

In an example, on the CSI reference resources, the determining the CSI feedback according to the CSI resources and the first information comprises at least one of: on the CSI reference resources, determining the CSI feedback according to power parameters and/or spatial domain parameters of the CSI resources; on the CSI reference resources, determining the CSI feedback according to parameters of the terminal device.

In an example, the CSI resources are determined according to the CSI resource configuration information from the base station.

In an example, the network energy saving information includes at least one of: network state information; network mode information; network switch information.

According to one aspect of the present disclosure, there is provided a method performed by a base station in a communication system, the method comprising: transmitting, to a terminal device, channel state information (CSI) resource configuration information for determining at least one of CSI resources, power parameters corresponding to the CSI resources, and spatial domain parameters corresponding to the CSI resources; and/or transmitting, to the terminal device, first information, wherein the first information is duplex information or network energy saving information; and/or transmitting, to the terminal device, indication information for indicating the terminal device to report CSI feedback; receiving the CSI feedback transmitted by the terminal device.

According to one aspect of the present disclosure, there is provided a terminal device, the terminal device including a transceiver and a controller coupled to the transceiver, where the controller is configured to perform the above method that can be performed by the controller.

According to one aspect of the present disclosure, there is provided a base station, the base station including a transceiver and a controller coupled to the transceiver, where the controller is configured to perform the above method that can be performed by the controller.

The present disclosure provides methods and devices for receiving and transmitting information/signals, which can improve the performance of channel state information (CSI) measurement and/or CSI reporting.

### Advantageous Effects of Invention

The present disclosure provides an effective and efficient method for receiving and transmitting information.

Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

The above and other aspects, features and advantages of the present invention will become more apparent from the following detailed description when taken in conjunction with the accompanying drawings.

FIG. 1 illustrates an overall structure of an example wireless communication network according to various embodiments of the present disclosure;

FIGS. 2a and 2b respectively illustrate a transmission path 200 and a reception path 250 in a wireless communication network according to various embodiments of the present disclosure;

FIGS. 3a and 3b respectively illustrate the structures of a user equipment (UE) and a base station in a wireless communication network according to various embodiments of the present disclosure;

FIG. 4 illustrates a Method 400 performed by a terminal device according to various embodiments of the present disclosure;

FIG. 5 illustrates an example of time-frequency domain resources according to an embodiment of the present disclosure;

FIG. 6 illustrates an example of time-frequency domain resources according to an embodiment of the present disclosure;

FIG. 7 illustrates an example of time-frequency domain resources according to an embodiment of the present disclosure;

FIG. 8 illustrates another method 800 performed by a terminal device according to various embodiments of the present disclosure;

FIG. 9 illustrates a method 900 performed by a base station according to various embodiments of the present disclosure;

FIG. 10 illustrates a structure 1000 of a terminal device according to various embodiments of the present disclosure;

FIG. 11 illustrates a structure 1100 of a base station according to various embodiments of the present disclosure.

### MODE FOR THE INVENTION

Hereinafter, embodiments of the present disclosure will be described in detail with reference to the accompanying drawings. It should be noted that in the drawings, the same or similar elements are denoted by the same or similar reference numerals as far as possible. In addition, detailed descriptions of known functions or configurations that may make the subject matter of the present disclosure unclear will be omitted.

In describing the embodiments of the present disclosure, descriptions related to technical contents that are well known in the field and not directly related to the present disclosure will be omitted. Such unnecessary description is omitted to prevent the main idea of the present disclosure from being blurred and to convey the main idea more clearly.

For the same reason, some elements may be exaggerated, omitted or schematically shown in the drawings. In addition, the size of each component does not fully reflect the actual size. In the drawings, the same or corresponding elements have the same reference numerals.

The advantages and features of the present disclosure and the way to achieve them will become clear by referring to the embodiments described in detail below in conjunction with the accompanying drawings. However, the present disclosure is not limited to the embodiments set forth below, but can be realized in various forms. The following examples are provided only to fully disclose this disclosure and to inform those skilled in the art of its scope, and this disclosure is turned only limited by the scope of the appended claims. Throughout this specification, the same or similar reference numerals indicate the same or similar elements.

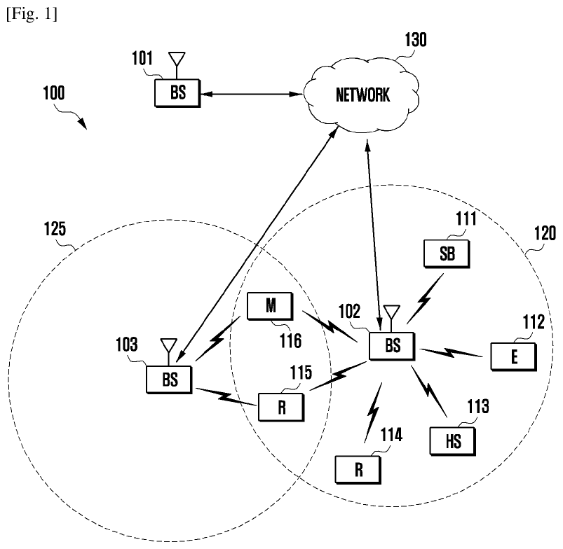

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

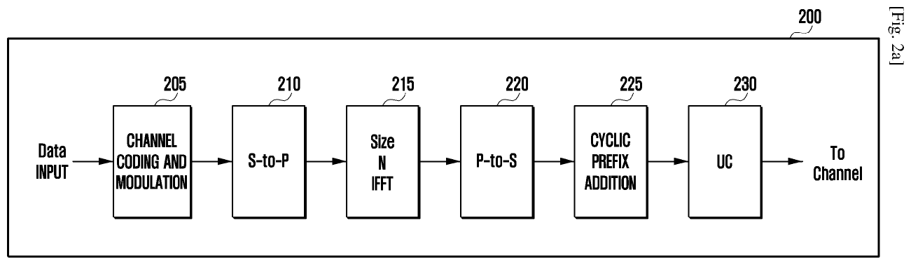

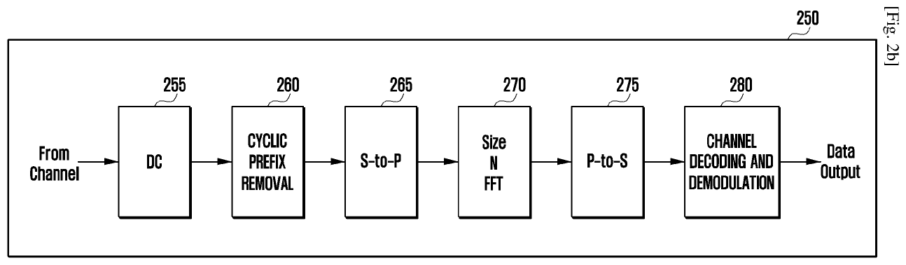

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency domain signals. The Parallel-to-Serial block 275 converts the parallel frequency domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

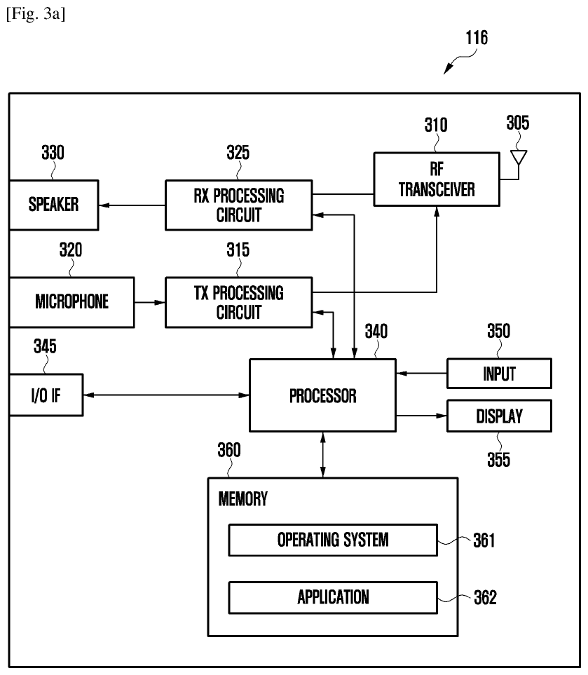

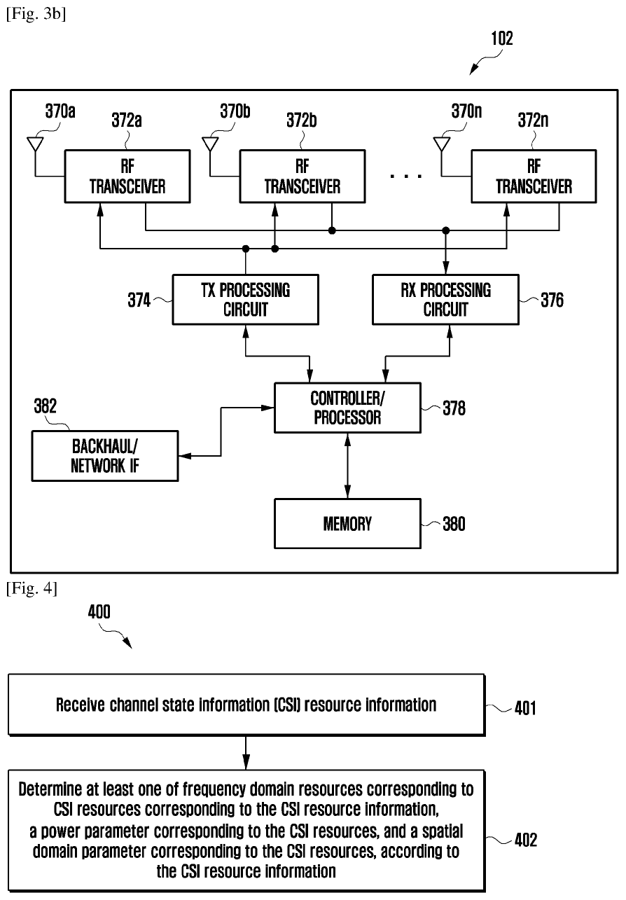

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In order to enhance the coverage of the 5G wireless communication system and reduce the system delay, one method is to use cross-division duplex (XDD) in the time division duplex (TDD) frequency band, or in the unpaired spectrum. More specifically, a method of subband non-overlapping duplex (SBFD) can be used. The subband nonoverlapping duplex means that the bandwidths of the base station (eg, carrier bandwidths) can be divided into multiple subbands. Herein, the uplink and downlink allocation ratios among multiple subbands may be different. The effect of this is that the base station can allocate a part of the bandwidth for uplink, or the uplink allocation ratio in time domain is large within the bandwidth. In this way, the opportunity for the UE to perform uplink transmission in the time domain is increased, thereby enhancing the uplink coverage capability of the UE and reducing time delay.

In addition, in order to reduce the power consumption of the 5G wireless communication system, one method is to switch off network devices at different level in different domain such as time domain, frequency domain, and spatial domain. When the base station is in an energy-saving state, in order to avoid significant degradation in the performance of terminal device in the area served by the base station, one method is to indicate network energy-saving information to the terminal device, so that the terminal device knows that the base station is in an energy-saving mode, so as to avoid sudden drop of performance through corresponding behaviors.

Currently, the following problems exist in the above SBFD and network energy saving scenarios:
#1. For SBFD, the CSI-related design does not take this duplex situation into consideration, and needs to be further improved.
#2. For the network energy saving, the existing CSI design does not take this situation into consideration and needs to be further improved.

In order to solve at least one of the above problems, this patent proposes a number of methods for enhancing CSI operations of the terminal device (CSI resources determination and/or CSI feedback acquisition) in the above SBFD and network energy saving scenarios. These methods can help the terminal device to perform CSI operations better, thereby improving the performance of the communication system.

The following is further explained with examples.

### Embodiment 1 (CSI Resources)

FIG. 4 illustrates a Method 400 performed by a terminal device according to various embodiments of the present disclosure. As shown in FIG. 4, at 401, the terminal device receives channel state information (CSI) resource information from the base station; at 402, the terminal device determines at least one of frequency domain resources corresponding to CSI resources corresponding to the CSI resource information, power parameters corresponding to the CSI resources, and spatial domain parameters corresponding to the CSI resources, according to the CSI resource information.

Here, the CSI resources can be understood as at least one of the following: CSI reference signal (CSI-RS) resources; CSI resources; CSI resources for channel measurement; CSI resources for interference measurement; non-zero power CSI (NZP-CSI) resources; CSI interference management resources. Optionally, the above CSI reference signals refer to at least one of the following: tracking reference signals (TRSs); CSI-RSs for beam management; CSI-RSs for CSI acquisition; synchronization signal blocks (SSBs). Optionally, the TRSs refer to the CSI-RSs configured with a TRS parameter (for example, trs-info). The CSI-RSs for beam management refer to CSI-RSs configured with a repetition parameter (for example, repetition) (optionally, the CSI-RSs are not configured with TRS parameters). The CSI-RSs for CSI acquisition are CSI-RSs configured without a TRS parameter (for example, trs-info) and without a repetition parameter (for example, repetition).

After receiving the above CSI resource information, the terminal device determines at least one of frequency domain resources, power parameters, and spatial domain parameters corresponding to the CSI resources according to the CSI resource information. The methods for determining the above-mentioned frequency domain resources, power parameters, and spatial domain parameters are further described below through different examples.

### Example 1-1 (Frequency Domain Resources, Two Frequency Domain Resource Indications)

The CSI resource information includes first frequency domain information of CSI resources (corresponding to the CSI resources) and second frequency domain information of the CSI resources; the terminal device determines frequency domain resources of the CSI resources according to the first frequency domain information and the second frequency domain information.

Optionally, the CSI resource information refers to frequency domain occupation information (for example, freqBand). Optionally, the CSI resource information refers to frequency domain occupation information of the CSI resources (for example, CSI-FrequencyOccupation).

Optionally, the first frequency domain information of the CSI resources and the second frequency domain information of the CSI resources included in the CSI resource information refer to first frequency domain occupation information (for example, freqBand) and second frequency domain occupation information (for example, freqBand2). Optionally, the first frequency domain resource occupation information includes information on starting resource block (RB) (for example, startingRB, optionally, the value of the starting RB is a multiple of 4) and information on the number of RB (for example, nrofRBs, optionally, the value of the number of RB is a multiple of 4). Optionally, the second frequency domain resource occupation information includes information on the starting RB (for example, startingRB, optionally, the value of the starting RB is a multiple of 4) and information on the number of RB (for example, nrofRBs, optionally, the value of the number of RB is a multiple of 4).

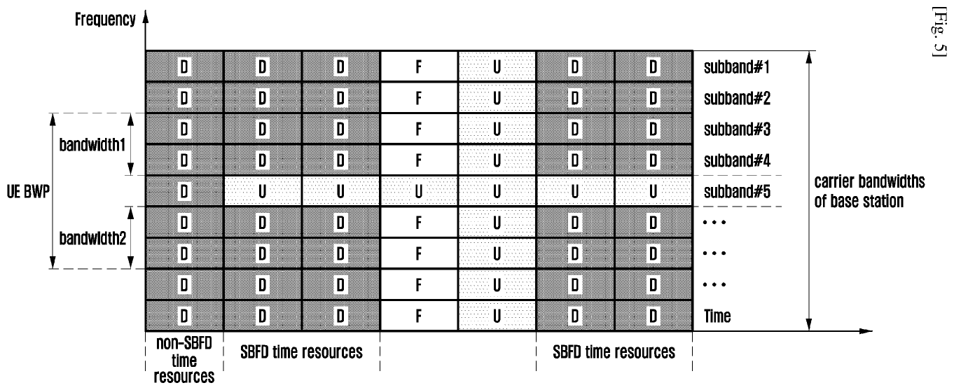

FIG. 5 illustrates an example of time-frequency domain resources according to an embodiment of the present disclosure. Specifically, as shown in FIG. 5, for an SBFD base station, SBFD operations are performed on a part of the carrier bandwidths (that is, uplink reception and downlink transmission are performed on the same time domain resources and different frequency domain resources, respectively). In Example 1, for SBFD time domain resources, subband #5 is used for uplink, and other subbands are used for downlink. Since the bandwidths of the terminal device (for example, UE bandwidth part (BWP)) spans the uplink subbands and the downlink subbands, for the downlink CSI resources, its frequency domain resources are divided into two parts (bandwidth #1 and Bandwidth #2). In this method, the base station performs frequency domain resource indication for two parts of bandwidths (bandwidth #1 and bandwidth #2), that is, indicates the first frequency domain resource and the second frequency domain resource (that is, freqBand and freqBand2).

Optionally, frequency domain resources corresponding to the first frequency domain information and frequency domain resources corresponding to the second frequency domain information do not overlap in the frequency domain. Specifically, the index of the starting RB corresponding to the second frequency domain information is greater than the sum of the index of the starting RB corresponding to the first frequency domain information and the number of RBs. For example, the index of the starting RB of the first frequency domain information is 1, the number of RBs is 28, and the index of the starting RB of the second frequency domain information X, then X>4+28. Optionally, the index of the starting RB corresponding to the second frequency domain information is greater than the sum of the index of the starting RB corresponding to the first frequency domain information and the number of RBs and is a multiple of four. For example, the index of the starting RB of the first frequency domain information is 4, the number of RBs is 28, and the index of the starting RB of the second frequency domain information is X, X=40, then X>4+28 and 40 is a multiple of 4.

Optionally, the terminal device determining frequency domain resources of the CSI resources according to the first frequency domain information and/or the second frequency domain information refers to one of the following methods:

### Method 1

The terminal device determines the frequency domain resource of the CSI resources according to the first frequency domain information and the frequency domain information corresponding to the BWP of the terminal device. Optionally, the terminal device determines the starting RB of the corresponding CSI resources according to the starting RB corresponding to the first frequency domain information and the starting RB of the BWP (for example, determines the starting RB of the corresponding CSI resources according to the larger (or smaller) value among the starting RB of the first frequency domain information and the starting RB of the BWP). Optionally, the terminal device determines the bandwidths of the corresponding CSI resources or the number of RBs of the CSI resources according to the number of the RBs of the first frequency domain information and the size of BWP (BWP size or the number of the RBs of BWP). For example, the bandwidths of the CSI resources or the number of RBs of the CSI resources is determined according to the smaller (or larger) among the size of the BWP and the number of RBs of the first frequency domain information. Optionally, the terminal device determines the bandwidths of the corresponding CSI resources or the number of RBs of the CSI resources according to the number of RBs of the first frequency domain information. Through the above description, the terminal device can determine the frequency domain position of the CSI resources according to the starting RB of the CSI-RSs and the bandwidths of the CSI resources.

Optionally, the CSI resources refer to the resources corresponding to TRS. That is, when the CSI resources are TRS, the terminal device determines the frequency domain resources corresponding to the TRSs according to the first frequency domain information and the frequency domain information corresponding to the BWP.

Optionally, the CSI resources refer to the resources corresponding to the CSI-RSs for beam management. That is, when the CSI resources are the CSI-RSs for beam management, the terminal device determines frequency domain resources corresponding to the CSI-RSs for beam management according to the first frequency domain information and the frequency domain information corresponding to the BWP.

Optionally, the CSI resources refer to resources corresponding to the CSI-RS for CSI acquisition. That is, when the CSI resources are the CSI-RSs for CSI acquisition, the terminal device determines frequency domain resources corresponding to the CSI-RSs for CSI acquisition according to the first frequency domain information and the frequency domain information corresponding to the BWP.

### Method 2

The terminal device determines the frequency domain resources of CSI resources according to the second frequency domain information and the frequency domain information corresponding to the BWP of the terminal device. Specifically, Method 2 is similar to Method 1. That is, in Method 2, the description of “first frequency domain information” in Method 1 is replaced by the description of “second frequency domain information”.

### Method 3

The terminal device determines the frequency domain resources of CSI resources according to one of the first frequency domain information and the second frequency domain information and the frequency domain information corresponding to the BWP of the terminal device. This method is similar to Method 1, that is, in Method 3, the description of “the first frequency domain information” in Method 1 is replaced by the description of “one of the first frequency domain information and the second frequency domain information”.

Optionally, one of the first frequency domain information and the second frequency domain information refers to the one with the larger corresponding bandwidth (or the number of RBs) of the first frequency domain information and the second frequency domain information. Optionally, if the bandwidths (or the number of RBs) corresponding to the first frequency domain information and the second frequency domain information are the same, it refers to the first frequency domain information.

Optionally, one of the first frequency domain information and the second frequency domain information refers to the one with the larger corresponding bandwidth of the CSI resources (or the number of RBs of the CSI-RS resources) of the first frequency domain information and the second frequency domain information the larger one. Optionally, if the bandwidths of the CSI resources corresponding to the first frequency domain information and the second frequency domain information (or the number of RBs of the CSI-RS resource) are the same, it refers to the first frequency domain information.

Optionally, one of the first frequency domain information and the second frequency domain information refers to the one with the smaller corresponding bandwidth of the CSI resources (or the number of RBs of the CSI-RS resources) of the first frequency domain information and the second frequency domain information the larger one. Optionally, if the bandwidths of the CSI resources corresponding to the first frequency domain information and the second frequency domain information (or the number of RBs of the CSI-RS resource) are the same, it refers to the first frequency domain information.

### Method 4

The terminal device determines the frequency domain resources of CSI resources according to the first frequency domain information, the second frequency domain information and the frequency domain information corresponding to the BWP of the terminal device. Optionally, the frequency domain resources of the CSI resources determined by Method 4 are the union of the frequency domain resources of the CSI resources determined by Method 1 and the frequency domain resources of the CSI resources determined by Method 2. That is, the frequency domain resources of CSI resources determined by Method 4 include both the frequency domain resources of CSI resources determined by Method 1 and the frequency domain resources of CSI resources determined by Method 2.

Here, the terminal device also receives first information; herein, the first information corresponds to the first time domain resources; on the first time domain resources, the terminal device determines the frequency domain resources of the CSI resources corresponding to the CSI resource information according to the CSI resource information.

In this disclosure, the first information refers to SBFD information or network energy saving information.

Optionally, the SBFD information may be understood as information related to SBFD (or used to indicate SBFD operations). Optionally, the SBFD information may be understood as information related to XDD (or used to indicate XDD operations).

Optionally, the network energy saving information refers to network state information. Here, the network can be understood as a network device. Optionally, the information indicates the state the network is at, for example, an on state, an off state, a normal state, and a sleep state.

Optionally, the network energy saving information refers to network mode information. Optionally, the information indicates the mode the network is in, for example, an on mode, an off mode, a normal mode, a sleep mode.

Optionally, the network energy saving information refers to network switch information. Specifically, the information indicates the switching state of the network, eg, on, off.

Here, the first information corresponding to the first time domain information refers to at least one of the following:

Optionally, the first information corresponds to the SBFD time domain resources (or the first information indicates the SBFD time domain resources), which is called the first time domain resources. Optionally, the first time domain resources are downlink symbols (for example, downlink symbols indicated semi-statically by the base station. For another example, downlink symbols indicated semi-statically by the base station via common signaling). Optionally, the first time domain resources are uplink symbols (for example, uplink symbols indicated semi-statically by the base station. For another example, uplink symbols indicated semi-statically by the base station via common signaling). Optionally, the first time domain resources are uplink symbols (for example, uplink symbols indicated semi-statically by the base station. For another example, uplink symbols indicated semi-statically by the base station via common signaling). Optionally, the first time domain resource are flexible symbols (for example, flexible symbols indicated semi-statically by the base station. Another example, flexible symbols indicated semi-statically by the base station via common signaling).

Optionally, the first information corresponds to network energy saving time domain resources (or the first information indicates network energy saving time domain resources), and is called the first time domain resources. Optionally, the first time domain resources are time domain resources for which the network device is off (or in a off mode, in a off state). Optionally, the first time domain resources are time domain resources for which the network device is sleeping (or in a sleep mode, in a sleep state).

Optionally, the method for the terminal device to determine the frequency domain resources corresponding to the CSI resources described in Example 1 refers to the method for the terminal device to determine the frequency domain resources corresponding to the CSI resources on the first time domain resources. Optionally, on non-first time domain resources, other methods (for example, legacy methods) can be used to determine the CSI resources.

### Example 1-2 (Frequency Domain Resources, One Frequency Domain Resource Indication+SBFD Frequency Domain Resource Indication)

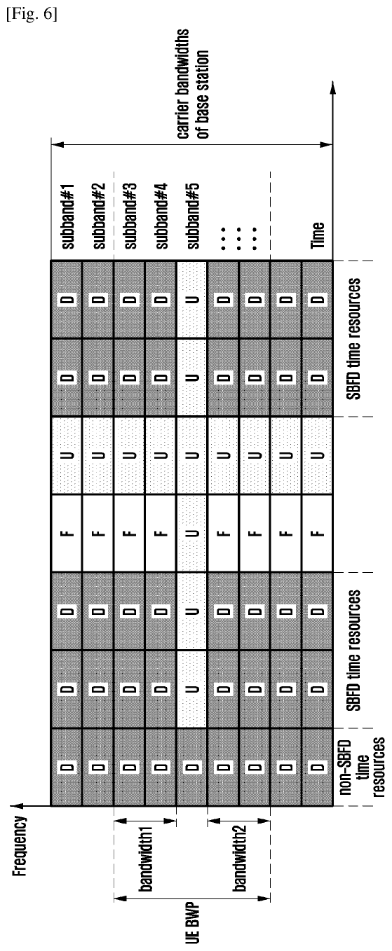

FIG. 6 illustrates an example of time-frequency domain resources according to an embodiment of the present disclosure. The terminal device receives the first information; herein, the first information corresponds to the third frequency domain resources (for example, the above-mentioned SBFD frequency domain resource indication, such as the bandwidth of subband #5 as shown in FIG. 6); the CSI resource information includes the fourth frequency domain resource information: the terminal device determines the frequency domain resources of the CSI resources at least according to the third frequency domain resources and/or the fourth frequency domain information.

In this disclosure, the first information refers to SBFD information or network energy saving information.

Optionally, the SBFD information may be understood as information related to SBFD (or used to indicate SBFD operations). Optionally, the SBFD information may be understood as information related to XDD (or used to indicate XDD operations).

Optionally, the network energy saving information refers to network state information. Here, the network can be understood as a network device. Optionally, the information indicates the state the network is at, for example, an on state, an off state, a normal state, and a sleep state.

Optionally, the network energy saving information refers to network mode information. Optionally, the information indicates the mode the network is in, for example, an on mode, an off mode, a normal mode, a sleep mode.

Optionally, the network energy saving information refers to network switch information. Optionally, the information indicates the switching state of the network, eg, on, off.

Here, the first information corresponding to the third frequency domain resources refer to at least one of the following:

Optionally, the first information corresponds to SBFD frequency domain resources, which are called third frequency domain resources. Optionally, the third frequency domain resources corresponds to the starting RB (for example,

$${N}_{SBFD}^{start} ,$$

optionally, the value of the starting RB is a multiple of 4) and/or the number of RBs (for example,

$${N}_{SBFD}^{size} ,$$

optionally, the value of the number of RBs is a multiple of 4).

Optionally, the first information corresponds to network energy-saving frequency domain resources, which are referred to as third frequency domain resources. Optionally, the third frequency domain resources corresponds to the starting RB (for example,

$${N}_{NES}^{start} ,$$

optionally, the value of the starting RB is a multiple of 4) and/or the number of RBs (for example,

$${N}_{NES}^{size} ,$$

optionally, the value of the number of RBs is a multiple of 4). Optionally, the third frequency domain resources correspond to one or more cells or component carriers (CCs). Optionally, the third frequency domain resources are frequency domain resources for which the network device is off (or in a off mode, in a off state). Optionally, the third frequency domain resources are frequency domain resources where the network device is sleeping (or in a sleep mode, in a sleep state).

In the following description, it is taken as an example that the third frequency domain resources are the frequency domain resources corresponding to the SBFD information. Similar descriptions are also applicable to the case where the third frequency domain resources are the frequency domain resources corresponding to the network energy saving information.

In addition, the fourth frequency domain information included in the CSI resource information refers to fourth frequency domain occupation information (for example, freqBand). Specifically, the fourth frequency domain resource occupation information includes information about the starting RB (for example, startingRB, optionally, the value of the starting RB is a multiple of 4) and information about the number of RBs (for example, nrofRBs, optionally, the value of the number of RBs is a multiple of 4).

Optionally, as shown in FIG. 6, for an SBFD base station, the SBFD operations are performed on a part of the carrier bandwidths (that is, uplink reception and downlink transmission can be performed on the same time domain resource and different frequency domain resources, respectively). In Example 2, for SBFD time domain resources, subband #5 is used for uplink, and other subbands are used for downlink. Since the bandwidths (for example, BWP) of the terminal device span the uplink subbands and the downlink subbands, for the downlink CSI resources, its frequency domain resources are divided into two parts (bandwidth #1 and bandwidth #2). In this method, the base station implicitly indicates bandwidth #1 and bandwidth #2 via frequency domain resource indication for CSI resources and frequency domain resource indication for SBFD.

Optionally, the terminal device determining the frequency domain resource of the CSI resources according to the third frequency domain resources and/or the fourth frequency domain information refers to one of the following methods:

### Method 1

The terminal device determines the frequency domain resources of CSI resources according to the frequency domain information corresponding to the third frequency domain resources and the BWP of the terminal device. Optionally, the terminal device determines the starting RB of the corresponding CSI resources according to the starting RB corresponding to the third frequency domain resources and the starting RB of the BWP (for example, the starting RB of the corresponding CSI resources is determined according to the larger (or smaller) value among the starting RB corresponding to the third frequency domain resources and the starting RB of the BWP). Optionally, the terminal device determines the bandwidths of the corresponding CSI resources or the number of RBs of the CSI resources according to the number of RBs corresponding to the third frequency domain resources and the size of the BWP (a BWP size or the number of RBs of the BWP). Optionally, the terminal device determines the ending RB of the corresponding CSI resources according to the smaller (or larger) value among the ending RB corresponding to the third frequency domain resources and the ending RB of the BWP. Optionally, the bandwidths (or the number of RBs) of CSI resources are determined by comparing the starting RB and the ending RB of the CSI resources. For example, the number of RBs of CSI resources is the ending RB value of CSI resources minus the starting RB value of CSI resources plus 1. Optionally, the terminal device determines the bandwidths of the corresponding CSI resources or the number of RBs of the CSI resources according to the number of RBs corresponding to the third frequency domain resources. Through the above description, the terminal device can determine the frequency domain positions of CSI resources according to the starting RB of the CSI-RS and the bandwidths of CSI resources.

Optionally, the CSI resources refer to resources corresponding to the TRS. That is, when the CSI resources are TRSs, the terminal device determines the frequency domain resources corresponding to the TRSs according to the third frequency domain resources and the frequency domain information corresponding to the BWP.

Optionally, the CSI resources refer to the resources corresponding to the CSI-RSs used for beam management. That is, when the CSI resources are CSI-RSs used for beam management, the terminal device determines the frequency domain resources corresponding to the CSI-RSs used for beam management according to the third frequency domain resources and the frequency domain information corresponding to the BWP.

Optionally, the CSI resources refer to the resources corresponding to the CSI-RSs used for CSI acquisition. That is, when the CSI resources are CSI-RSs used for CSI acquisition, the terminal device determines the frequency domain resources corresponding to the CSI-RSs used for CSI acquisition according to the third frequency domain resources and the frequency domain information corresponding to the BWP.

A case in which Method 1 described here is applicable is shown in FIG. 7.

Optionally, using Method 1 to determine the frequency domain resources of the CSI resources needs to meet the following conditions: the starting RB of the BWP is less than or equal to the ending RB of the third frequency domain resources; and the ending RB of the BWP is greater than or equal to the starting RB of the third frequency domain resources.

### Method 2

The terminal device determines the frequency domain resources of CSI resources according to the fourth frequency domain information and the frequency domain information corresponding to the BWP of the terminal device. Optionally, the terminal device determines the starting RB of the corresponding CSI resources according to the starting RB of the fourth frequency domain information and the starting RB of the BWP (for example, the starting RB of the corresponding CSI resources is determined according to the larger (or smaller) value among the starting RB of the fourth frequency domain information and the starting RB of the BWP). Optionally, the terminal device determines the bandwidths of the corresponding CSI resources or the number of RBs of the CSI resources according to the number of RBs of the fourth frequency domain information and the size of the BWP (a BWP size or the number of RBs of the BWP). For example, the bandwidths of the CSI resources or the number of RBs of the CSI resources are determined according to the smaller (or larger) of the BWP size and the number of RBs of the fourth frequency domain information. Optionally, the terminal device determines the bandwidths of the corresponding CSI resources or the number of RBs of the CSI resources according to the number of RBs of the fourth frequency domain information. Through the above description, the terminal device can determine the frequency domain positions of CSI resources according to the starting RB of CSI-RSs and the bandwidths of CSI resources.

Optionally, the CSI resources refer to resources corresponding to the TRSs. That is, when the CSI resources are TRSs, the terminal device determines the frequency domain resources corresponding to the TRSs according to the fourth frequency domain information and the frequency domain information corresponding to the BWP.

Optionally, the CSI resources refer to the resources corresponding to the CSI-RSs used for beam management. That is, when the CSI resources are CSIs used for beam management, the terminal device determines the frequency domain resources corresponding to the TRSs according to the fourth frequency domain information and the frequency domain information corresponding to the BWP.

Optionally, the CSI resources refer to the resources corresponding to the CSI-RSs used for CSI acquisition. That is, when the CSI resources are the CSI-RSs used for CSI acquisition, the terminal device determines the frequency domain resources corresponding to the TRSs according to the fourth frequency domain information and the frequency domain information corresponding to the BWP.

Optionally, the bandwidths corresponding to the BWP do not overlap with the third frequency domain resources (in other words, the condition to be met when using this method is that the bandwidths corresponding to the BWP (frequency domain resources) and the bandwidths corresponding to the third frequency domain information (frequency domain resources) do not overlap). Optionally, the bandwidths corresponding to the BWP do not overlap with the third frequency domain resources means that the value of the maximum RB corresponding to the BWP (for example,

$${N}_{BWP}^{size} + {N}_{BWP}^{start} )$$

is smaller than the value of the starting RB corresponding to the third frequency domain resources (for example,

$${N}_{SBFD}^{start} ) ,$$

or, the value of the starting RB corresponding to the BWP (for example,

$${N}_{BWP}^{start} )$$

is greater than the value of the ending RB corresponding to the third frequency domain resources

$$( {N}_{SBFD}^{size} + {N}_{SBFD}^{start} ) .$$

### Method 3

The terminal device determines the frequency domain resources of CSI resources according to the third frequency domain resources, the fourth frequency domain information and the frequency domain information corresponding to the BWP of the terminal device.

Optionally, the terminal device determines the starting RB of the corresponding CSI resources according to the ending RB

$$( {N}_{SBFD}^{size} + {N}_{SBFD}^{start} )$$

corresponding to the third frequency domain resources. For example, the starting RB of the CSI resources is the ending RB corresponding to the third frequence domain resources plus one

$$( {N}_{SBFD}^{size} + {N}_{SBFD}^{start} + 1 ) .$$

For another example, the starting RB of the CSI resources is determined according to the ending RB corresponding to the third frequency domain resources and the number of RBs of guardband

$$( {N}_{Guard}^{} ) .$$

Specifically, the starting RB of the CSI resources is

$${N}_{SBFD}^{size} + {N}_{SBFD}^{start} + {N}_{Guard}^{} + 1.$$

Optionally, the terminal device determines the bandwidth of the corresponding CSI resources or the number of RBs of the CSI resources according to the number of RBs of the fourth frequency domain information. Optionally, the terminal device determines the bandwidths of the corresponding CSI resources or the number of RBs of the CSI resources according to the sum of the number of RBs of the fourth frequency domain information (the difference between the ending RB of the BWP and the above-determined starting point of the CSI plus 1). That is, the smaller of the number of RBs in the fourth frequency domain information and (the difference between the ending RB of the BWP and the above-determined starting RB of the CSI plus 1) is the bandwidth of the CSI resources.

Optionally, the starting RB corresponding to the BWP overlaps with the third frequency domain resources (in other words, the condition to be met when using this method is that the starting RB corresponding to the BWP overlaps with the third frequency domain resources). Optionally, the ending RB corresponding to the BWP is greater than the ending RB of the third frequency domain resources (or another condition to be met when using this method is that the ending RB corresponding to the BWP is greater than the ending RB of the third frequency domain resources). Optionally, the overlapping of the starting RB corresponding to the BWP and the third frequency domain resources means that the value of the starting RB corresponding to the BWP (for example) is greater than or equal to the value of the starting RB corresponding to the third frequency domain resources (for example,

$${N}_{S B F D}^{start} ) ,$$

and the value of the starting RB corresponding to the BWP (for example,

$${N}_{B W P}^{s t a r t} )$$

is less than or equal to the value of the ending RB corresponding to the third frequency domain resources

$$( {N}_{S B F D}^{s i z e} + {N}_{SBFD}^{start} ) .$$

### Method 4

The terminal device determines the frequency domain resources of the CSI resources according to the third frequency domain resources, the fourth frequency domain information and the frequency domain information corresponding to the BWP of the terminal device.

Optionally, the terminal device determines the ending RB of the corresponding CSI resources according to the starting RB

$$( {N}_{S B F D}^{start} )$$

corresponding to the third frequency domain resources. For example, the ending RB of the CSI resources is the starting RB

$$( {N}_{S B F D}^{start} )$$

corresponding to the third frequency domain resources. For another example, the starting RB of the CSI resources is determined according to the starting RB corresponding to the third frequency domain resources and the number of RBs

$$( {N}_{G u a r d}^{} )$$

of the guardband. Specifically, the starting RB of the CSI resources is

$${N}_{S B F D}^{s t a r t} - {N}_{G u a r d}^{} .$$

The starting RB of the fourth frequency domain information and the starting RB of the BWP determine the starting RB of the corresponding CSI resources (for example, according to the larger (or, the smaller) value of the starting RB of the first frequency domain information and the starting RB of the BWP determines the starting RB of the corresponding CSI resources).

Optionally, the bandwidths of the CSI resources are equal to the difference between the above determined ending RB of the CSIs and the starting RB of the CSIs plus 1.

Optionally, in this method, the ending RB of the BWP is in the third frequency domain resources; and the starting RB of the BWP is smaller than the starting RB of the third frequency domain resources.

### Method 5

The terminal device determines the frequency domain resources of the CSI resources according to the third frequency domain resources, the fourth frequency domain information and the frequency domain information corresponding to the BWP of the terminal device. Herein, the frequency domain resources of the CSI resources are divided into two parts (the first part and the second part).

Optionally, the starting point of the first part is determined by the starting RB of the fourth frequency domain information and the starting RB of the BWP. For example, the starting point of the first part is determined according to the larger value of the starting RB of the fourth frequency domain information and the starting RB of the BWP.

Optionally, the ending point of the first part is determined by the starting RB corresponding to the third frequency domain resources. For example, the ending point of the first part is minus one

$$( {N}_{S B F D}^{start} - 1 )$$

from the starting RB corresponding to the third frequency domain resources. For another example, the ending point of the first part is determined according to the starting RB corresponding to the third frequency domain resources and the number of RBs

$$( {N}_{Guard}^{} )$$

of the guardband. Specifically, the ending point RB of the first part is

$${N}_{S B F D}^{start} - {N}_{Guard}^{} - 1.$$

Optionally, the bandwidths (or number of RBs) of the first part is obtained by subtracting the ending point of the first part from the starting point of the first part. For example, the number of RBs of the first part is the difference between the ending RB value of the first part and the starting RB value of the first part plus one.

Optionally, the starting point of the second part is determined by the ending RB corresponding to the third frequency domain resources. For example, the RB value of the starting point of the second part is the value of the ending RB of the third frequency domain information plus one

$$( {N}_{S B F D}^{s i z e} + {N}_{S B F D}^{start} + 1 ) .$$

Optionally, the bandwidths (or the number of RBs) of the second part is determined by the number of RBs of the fourth frequency domain information. For example, the number of RBs of the second part is determined according to the number of RBs of the fourth frequency domain information and the number of RBs of the first part. Specifically, the number of RBs of the second part is the number of RBs of the fourth frequency domain information minus the number of RBs of the first part.

Optionally, the ending point of the second part is determined by the bandwidths (or the number of RBs) of the second part and the ending RB of the BWP. For example, the ending point RB of the second part is determined according to the RB with the corresponding larger value of the ending RB determined by the bandwidths (or number of RBs) of the second part and the ending RB of the BWP.

The terminal device also receives first information; herein, the first information corresponds to the first time domain resources; on the first time domain resources, the terminal device determines the frequency domain resources of the CSI resources corresponding to the CSI resource information according to the CSI resource information.

Here, the first information corresponding to the first time domain resource refers to at least one of the following:

Optionally, the first information corresponds to the SBFD time domain resources (or the first information indicates the SBFD time domain resources), which is called the first time domain resources. Optionally, the first time domain resources are downlink symbols (for example, downlink symbols indicated semi-statically by the base station. For another example, downlink symbols indicated semi-statically by the base station via common signaling). Optionally, the first time domain resources are uplink symbols (for example, uplink symbols indicated semi-statically by the base station. For another example, uplink symbols indicated semi-statically by the base station via common signaling). Optionally, the first time domain resources are uplink symbols (for example, uplink symbols indicated semi-statically by the base station. For another example, uplink symbols indicated semi-statically by the base station via common signaling). Optionally, the first time domain resource are flexible symbols (for example, flexible symbols indicated semi-statically by the base station. Another example, flexible symbols indicated semi-statically by the base station via common signaling).

Optionally, the first information corresponds to network energy saving time domain resources (or the first information indicates network energy saving time domain resources), and is called the first time domain resources. Optionally, the first time domain resources are time domain resources for which the network device is off (or in a off mode, in a off state). Optionally, the first time domain resources are time domain resources for which the network device is sleeping (or in a sleep mode, in a sleep state).

Optionally, the method for the terminal device to determine the frequency domain resources corresponding to the CSI resources described in this example refers to the method for the terminal device to determine the frequency domain resources corresponding to the CSI resources on the first time domain resources. Furthermore, on non-first time domain resources, other methods (for example, legacy methods) are used to determine the CSI.

For example, for the case where the first time domain resources are uplink symbols (for example, the uplink symbols indicated semi-statically by the base station. For another example, the uplink symbols indicated semi-statically by the base station via common signaling), on the first time domain resources, the above first method is performed to determine the frequency domain resources corresponding to the CSI resources.

For another example, for the case where the first time domain resources are downlink symbols (for example, the downlink symbols indicated semi-statically by the base station. For another example, the downlink symbols indicated semi-statically by the base station via common signaling), on the first time domain resources, at least one of the above Method 2, Method 3, Method 4, and Method 5 is performed to determine the frequency domain resources corresponding to the CSI resources.

### Example 2-1 (Power Parameters, Explicitly Indicating the First Power Parameter and the Second Power Parameter)

The CSI resources corresponds to the first power parameter and the second power parameter. Here, the CSI resources corresponding to the first power parameter and the second power parameter means that the terminal device receives two indications for indicating the CSI resource power parameters.

Taking the CSI resources as SSB resources as an example, the terminal device receives SSB resource information, and the SSB resource information corresponds to the first power parameter (for example, the parameter used to indicate the SSB downlink transmission power, ss-PBCH-BlockPower) and the second power parameter indication (for example, the parameter used to indicate the SSB downlink transmission power, ss-PBCH-BlockPower1).

Taking the CSI resources as CSI-RS resources as an example, the terminal device receives CSI-RS resource information, and the CSI-RS resource information corresponds to or includes a first power parameter indication (for example, the parameter used to indicate the proportion of NZP CSI-RS energy per resource element (EPRE) and the SSB EPRE, powerControlOffsetSS) and the second power parameter indication (for example, the parameter used to indicate the proportion of NZP CSI-RS EPRE and the SSB EPRE, powerControlOffsetSS1).

Taking the CSI resources as the CSI-RS resources as an example, the terminal device receives the CSI-RS resource information, and the CSI-RS resource information corresponds to or includes the first power parameter indication (for example, the parameter used to indicate the ratio of Physical Downlink Shared Channel (PDSCH) EPRE and NZP CSI-RS EPRE, powerControlOffset) and the second power parameter indication (for example, the parameter used to indicate the ratio of PDSCH EPRE and NZP CSI-RS EPRE, powerControlOffset1).

The terminal device also receives first information; herein the first information corresponds to the first time domain resources; on the first time domain resources, the terminal device determines that the power parameters corresponding to the CSI resources is the second power parameter.

Here, refer to Example 1 for the description of the first information, the first time domain information and the first time domain resources.

On the first time domain resources, the terminal device determines that the power parameter corresponding to the CSI resources is the second power parameter means that the terminal device determines on the first time domain resources that the power parameter corresponding to the CSI resources is the second power parameter.

Optionally, the method for the terminal device to determine the second power parameter corresponding to the CSI resources described in Example 2-1 refers to the method for the terminal device to determine the frequency domain resources corresponding to the CSI resources on the first time domain resources. Optionally, on non-first time domain resources, the terminal device determines that the power parameter corresponding to the CSI resources is the other power parameter (for example, the first power parameter).

Taking the CSI resource as CSI-RS as an example, when the time domain resource of the CSI-RS is in the first time domain resource, the power parameter corresponding to the CSI-RS is the second power parameter (for example, powerControlOffsetSS1). When the time domain resources of the CSI-RS are not in the first time domain resources, the power parameter corresponding to the CSI-RSs is the first power parameter (for example, powerControlOffsetSS).

### Example 2-2 (Power Parameters, Implicitly Indicating a Second Power Parameter)

The CSI resources corresponds to the first power parameter and the second power parameter; the second power parameter is determined according to the first power parameter.

Here, the CSI resources corresponding to the first power parameter means that the terminal device receives one indication for indicating the CSI resource power parameters (for example, the first power parameter).

Taking the CSI resource as SSB resource as an example, the terminal device receives SSB resource information, and the SSB resource information corresponds to the first power parameter (for example, a parameter used to indicate SSB downlink transmission power, ss-PBCH-BlockPower).

Taking the CSI resources as CSI-RS resources as an example, the terminal device receives CSI-RS resource information, and the CSI-RS resource information corresponds to or includes a first power parameter indication (for example, the parameter used to indicate the proportion of NZP CSI-RS EPRE and the SSB EPRE, powerControlOffsetSS).

Taking the CSI resources as CSI-RS resources as an example, the terminal device receives CSI-RS resource information, and the CSI-RS resource information corresponds to or includes a first power parameter indication (for example, the parameter used to indicate the ratio of PDSCH EPRE and NZP CSI-RS EPRE, powerControlOffset).

Unlike Example 2-1, in Example 2-2, the second power parameter is determined according to the first power parameter. Specifically, the second power parameter is determined by the following method:

### Method 1

The second power parameter is determined by the first power parameter according to a predefined rule.

Optionally, an offset value A (for example, an offset) between the second power parameter and the first power parameter is predefined. Optionally, the unit of A is dB. Here, A is, for example, 1 dB, 1.5 dB, 3 dB, 6 dB. For example, if the first power parameter is X, the second power parameter is X+A. Here, the reason why the second power parameter increases is that the base station performs power boost for downlink coverage. For another example, if the first power parameter is X, then the second power parameter is X-A. The reason is that the second power parameter is reduced by A is that for SBFD operation (or XDD operation), the base station needs to perform uplink and downlink transmission at the same time. In order to have better uplink and downlink isolation (to reduce interference), the base station can only use half of the antenna panel for downlink transmission, so in this case the power is reduced compared to the case where the entire antenna panel is used for downlink. For another example, the value of A is related to the frequency domain range (frequency range) (for example, FR 1, FR 2) or, the value of A is determined based on the frequency domain range (frequency range). Optionally, the value of A can be 3 dB at FR1. The value of A can be 6 dB at FR2.

Optionally, the offset value (A) between the second power parameter and the first power parameter is determined according to the first ratio. Herein, the first ratio refers to a ratio of frequency domain resources. Optionally, the first ratio refers to the ratio between frequency domain resource #1 of the CSI resources and frequency domain resource #2 of the CSI resources. Optionally, the first ratio refers to a ratio between frequency domain resource #2 of the CSI resources and frequency domain resource #1 of the CSI resources. Optionally, the frequency domain resource #1 refers to the frequency domain resources corresponding to the CSI resources in the non-first time domain resources; the frequency domain resource #2 refers to the frequency domain resources corresponding to the CSI resources in the first time domain resources. Optionally, frequency domain resource #1 is determined by the fourth frequency domain resource in Example 1-2 and the BWP bandwidths (or BWP RBs) corresponding to the terminal. Frequency domain resource #2 is a frequency domain resources of the CSI resources obtained by the method of Example 1-2.

### Method 2

The second power parameter is determined according to the indication of the base station and the first power parameter.

Optionally, the offset value (for example, offset) between the second power parameter and the first power parameter is Y. Herein, Y is indicated by the base station. For example, if the first power parameter is X, then the second power parameter is X+Y. Optionally, Y is positive, negative or 0. Optionally, the units of X and Y are dB. Through Method 2, the base station can flexibly adjust the power on the SBFD time domain resources, so as to perform better downlink transmission. Optionally, the default value of Y is 3 dB/6 dB.

Optionally, the second power parameter is determined according to the first power parameter and the downlink power indication. Optionally, the above Y is determined according to the downlink power indication from the base station. Optionally, the downlink power indication refers to a downlink transmission power adjustment (DL Tx Power Adjustment) indication. Optionally, the downlink power indication refers to power spectrum density (PSD) indication.

### Method 3

The offset value between the first power parameter and the second power parameter is determined according to base station instructions and predefined rules. Optionally, the offset value is related to Y and A. Herein for the determination method of A, refer to Method 1; for the determination method of Y, refer to Method 2. For example, when the first power parameter is X, the second power parameter is X−A+Y.

Optionally, the terminal device further receives first information; herein, the first information corresponds to the first time domain resources; on the first time domain resources, the terminal device determines that the power parameter corresponding to the CSI resources is the second power parameter.

Here, refer to Example 1 for the description of the first information, the first time domain information and the first time domain resources.

On the first time domain resources, the terminal device determines that the power parameter corresponding to the CSI resources is the second power parameter means that the terminal device determines on the first time domain resources that the power parameter corresponding to the CSI resources is the second power parameter.

Optionally, the method for the terminal device to determine the second power parameter corresponding to the CSI resources described in Example 2-2 refers to the method for the terminal device to determine the frequency domain resources corresponding to the CSI resources on the first time domain resources. Optionally, on non-first time domain resources, the terminal device determines that the power parameter corresponding to the CSI resources is the other power parameter (for example, the first power parameter).

Taking the CSI resource as CSI-RS as an example, when the time domain resource of the CSI-RS is in the first time domain resources, the power parameter corresponding to the CSI-RS is the second power parameter. When the time domain resource of the CSI-RS is not in the first time domain resource, the power parameter corresponding to the CSI-RS is the first power parameter (for example, powerControlOffsetSS).

### Example 3-1 (Spatial Domain Parameters, Explicitly Indicating First Spatial Domain Parameter and Second Spatial Domain Parameter)

The CSI resources corresponds to the first spatial domain parameter and the second spatial domain parameter; optionally, the CSI resources corresponds to the first spatial domain parameter and the second spatial domain parameter means that the terminal device receives two indications for indicating the CSI resources spatial domain parameters.

Taking the CSI resources as the CSI-RS resources as an example, the terminal device receives the CSI-RS resource information, and the CSI-RS resource information corresponds to or includes the first spatial domain parameter indication (for example, the parameter used to indicate the number of CSI-RS ports, nrofPorts) and the second spatial domain parameter indication (for example, the parameter used to indicate the number of CSI-RS ports, nrofPorts1).

Taking the CSI resource as the CSI-RS resource as an example, the terminal device receives the CSI-RS resource information, and the CSI-RS resource information corresponds to or includes the first spatial domain parameter indication (for example, the parameter used to indicate quasi-co-location (QCL) information, qcl-InfoPeriodicCSI-RS) and second spatial domain parameter indication (e.g., parameter used to indicate QCL information, qcl-InfoPeriodicCSI-RS1). Optionally, the QCL information refers to a transmission configuration indicator (TCI) state. Optionally, the TCI state indicates a QCL source RS and a QCL type of the CSI-RS. Optionally, the QCL type is at least one of QCL type A, type B, type C, and type D.

Optionally, the QCL parameter (or reference signal) corresponding to the first spatial parameter (for example, qcl-InfoPeriodicCSI-RS) and the QCL parameter (or reference signal) corresponding to the second spatial parameter (for example, qcl-InfoPeriodicCSI-RS1) are the same. Optionally, the QCL type is QCL type D. Optionally, the QCL type is QCL type D.

The terminal device also receives first information; herein, the first information corresponds to the first time domain resources; on the first time domain resources, the terminal device determines that the spatial domain parameter corresponding to the CSI resources is the second spatial domain parameter.

Here, refer to Example 1 for the description of the first information, the first time domain information and the first time domain resources.

On the first time domain resources, the terminal device determines that the spatial domain parameter corresponding to the CSI resources is the second spatial domain parameter means that the terminal device determines on the first time domain resources that the spatial domain parameter corresponding to the CSI resources is the second spatial domain parameter.

Optionally, the method for the terminal device to determine the second spatial domain parameter corresponding to the CSI resources described in Example 3-1 refers to the method for the terminal device to determine the frequency domain resources corresponding to the CSI resources on the first time domain resources. Optionally, on non-first time domain resources, the terminal device determines that the spatial domain parameter corresponding to the CSI resources is the other spatial domain parameter (for example, the first spatial domain parameter).

Taking the CSI resource as CSI-RS as an example, when the time domain resources of the CSI-RS are in the first time domain resource, the spatial domain parameter corresponding to the CSI-RS is the second spatial domain parameter (for example, nrofPorts1). When the time domain resource of the CSI-RS are not in the first time domain resources, the spatial domain parameter corresponding to the CSI-RS is the first spatial domain parameter (for example, nrofPorts).

### Example 3-2 (Spatial Domain Parameters, Implicitly Indicating a Second Spatial Domain Parameter)

The CSI resources corresponds to the first spatial domain parameter and the second spatial domain parameter; the second spatial domain parameter is determined according to the first spatial domain parameter.

Optionally, the fact that the CSI resources corresponds to the first spatial domain parameter means that the terminal device receives one indication for indicating the spatial domain parameters of the CSI resources.

Taking the CSI resource as a CSI-RS resource as an example, the terminal device receives CSI-RS resource information, and the CSI-RS resource information corresponds to or includes a first spatial domain parameter indication (for example, the parameter used to indicate the number of CSI-RS ports, nrofPorts).

Taking the CSI resources as CSI-RS resources as an example, the terminal device receives CSI-RS resource information, and the CSI-RS resource information corresponds to or includes the first spatial domain parameter indication (for example, for example, the parameter used to indicate QCL information, qcl-InfoPeriodicCSI-RS).

Optionally, the first spatial domain parameter corresponding to the CSI resource refers to the QCL parameters corresponding to the CSI resource.

Taking the CSI resource as CSI-RS resource as an example, the QCL parameter corresponding to the CSI resources refer to at least one of the following: the source reference signal (source RS) corresponding to the CSI-RS); the QCL source reference signal (QCL source RS) corresponding to the CSI-RS; the reference signal QCLed with the CSI-RSs; SSB QCLed with the CSI-RS. Optionally, the type corresponding to the QCL is QCL type D. Optionally, the type corresponding to the QCL is QCL type A, QCL type B, or QCL type C.

Unlike Example 3-1, in Example 3-2, the second spatial parameter is determined according to the first spatial parameter. Specifically, the second spatial parameter is determined by the following method:

### Method 1

The second spatial domain parameter is determined by the first spatial domain parameter according to a predefined rule.

### Method 1-1

In Method 1-1, the first spatial domain parameter is the first port number of CSI-RSs (for example, indicated by the parameter nrofPorts indicated by the base station); the second spatial domain parameter is the second port number of CSI-RS. Optionally, the second port number of the CSI-RS is the same as the first port number of the CSI-RSs. Optionally, the second port number of the CSI-RS is half of the first port number of the CSI-RSs.

Optionally, the CSI-RSs are CSI-RSs used for CSI acquisition. The first port number of the CSI-RSs is P (for example, P∈[1, 2, 4, 8, 12, 16, 24, 32]), then the second port number of the CSI-RS is half of the first port number of the CSI-RSs, that is, P/2.

Optionally, the CSI-RSs are CSI-RSs used for beam management, and the first port number of the CSI-RSs is P (P=2), then the second port number of the CSI-RS is half of the first port number of the CSI-RSs, that is, P/2 (P/2=1).

### Method 1-2

The second spatial domain parameter is determined by the first spatial domain parameter according to a predefined rule.

In method 1-2, the first spatial domain parameter is the QCL parameter of the CSI-RS corresponding to the CSI resource; the second spatial domain parameter is the QCL parameter of the CSI-RS corresponding to the CSI resource. Optionally, the second spatial domain parameter is determined according to the first spatial domain parameter. Optionally, the second spatial domain parameter is the same as the first spatial domain parameter. Optionally, the type corresponding to the QCL is QCL type D. Optionally, the type corresponding to the QCL is QCL type A, QCL type B, or QCL type C.

### Method 1-3

The second spatial domain parameter is determined by the first spatial domain parameter according to a predefined rule. Optionally, the predefined rule means that the second spatial domain parameter is a subset of the first spatial domain parameter. In methods 1-3, the first spatial domain parameter corresponds to the first antenna port of the CSI-RS (for example, obtained according to the parameter nrofPorts indicated by the base station); the second spatial domain parameter corresponds to the second antenna port of the CSI-RS. Here, the spatial domain parameter corresponding to the antenna port of the CSI-RS can be understood as the spatial domain parameter corresponding to the antenna port identifier (ID) the CSI-RS.

Optionally, the CSI-RS are CSI-RS used for CSI acquisition. The second antenna port of the CSI-RSs being a subset of the first antenna port of the CSI-RSs means that the second port number of the CSI-RS is half of the first port number of the CSI-RS. For example, the first port number of the CSI-RSs used for CSI acquisition is P∈[1, 2, 4, 8, 12, 16, 24, 32], and the corresponding antenna ports of the CSI-RS are [3000, . . . , 3000+P−1]. In this case, the second antenna ports of the CSI-RSs used for CSI acquisition are [3000, . . . , 3000+P/2−1]. For another example, the first port number of the CSI-RSs used for CSI acquisition is P∈[1, 2, 4, 8, 12, 16, 24, 32], and the corresponding antenna ports of the CSI-RS are [3000, . . . , 3000+P−1]. In this case, the second antenna ports of the CSI-RSs used for CSI acquisition is odd-numbered antenna ports or even-numbered antenna ports among the antenna ports of the CSI-RS.

### Method 2

The second spatial domain parameter is obtained according to the indication of the base station and the first spatial domain parameter.

### Method 2-1

In Method 2-1, the first spatial domain parameter is the first port number of the CSI-RSs (for example, the parameter nrofPorts indicated by the base station); the second spatial domain parameter is the second port number of the CSI-RS. Optionally, the second port number of the CSI-RS is determined according to the indication of the base station and the first port number of the CSI-RS.

Optionally, the CSI-RS are CSI-RS used for CSI acquisition. The first port number of the CSI-RS is P (for example, P∈[1, 2, 4, 8, 12, 16, 24, 32]),
and the base station indicates the ratio of the second port number of the CSI-RSs and the first port number of the CSI-RS is K (the ratio can be 1/2, 1/3). Then the second port number of the CSI-RSs is half of the first port number of the CSI-RSs, that is, P*K. Optionally, the base station indicates the ratio of the second port number of the CSI-RS and the first port number of the CSI-RSs is Q (the ratio can be 2 or 3). In this case, the second port number of the CSI-RSs is P/Q.

Optionally, the above description is also applicable to the case where the CSI-RSs are CSI-RSs used for beam management.

### Method 2-2

In Method 2-2, the first spatial domain parameter corresponds to the first antenna port of the CSI-RS (for example, obtained according to the parameter nrofPorts indicated by the base station); the second spatial domain parameter corresponds to the second antenna port of the CSI-RS.

Optionally, the CSI-RS are CSI-RS used for CSI acquisition. The second antenna port of the CSI-RS is determined according to the first antenna port of the CSI-RS and the indication of the base station. Optionally, the base station indication is a bitmap, and the second antenna port of the CSI-RS is determined according to the first antenna port of the CSI-RSs and the bitmap. For example, the first antenna port of the CSI-RSs is [3000, 3001, 3002, 3003], and the indication of the bitmap is ‘0010’, then the second antenna port of the CSI-RSs is determined according to the indication of 1 in the bitmap, that is 3002.

The terminal device also receives first information; herein, the first information corresponds to the first time domain resources; on the first time domain resources, the terminal device determines that the spatial domain parameter corresponding to the CSI resources is the second spatial domain parameter.

Here, refer to Example 1 for the description of the first information, the first time domain information and the first time domain resources.

On the first time domain resources, the terminal device determines that the spatial domain parameter corresponding to the CSI resources is the second spatial domain parameter means that the terminal device determines on the first time domain resources that the spatial domain parameter corresponding to the CSI resources is the second spatial domain parameter.

Optionally, the method for the terminal device to determine the second spatial domain parameter corresponding to the CSI resources described in Example 3-2 refers to the method for the terminal device to determine the frequency domain resources corresponding to the CSI resources on the first time domain resources. Optionally, on non-first time domain resources, the terminal device determines that the spatial domain parameter corresponding to the CSI resources is the other spatial domain parameter (for example, the first spatial domain parameter).

Taking the CSI resource as the CSI-RS as an example, when the time domain resources of the CSI-RSs are in the first time domain resources, the spatial domain parameter corresponding to the CSI-RSs is the second spatial domain parameter. When the time domain resources of the CSI-RS are not in the first time domain resources, the spatial domain parameter corresponding to the CSI-RS is the first spatial domain parameter.

The above examples (Example 1, Example 2, Example 3) can be combined arbitrarily.

The terminal device determines CSI feedback or reports CSI feedback according to at least one of frequency domain resources, power parameters, and spatial domain parameters of the CSI resources.

In Embodiment 1, the terminal device acquires at least one of frequency domain resources, power parameters, and spatial domain parameters of the CSI resources according to the method described above.

Optionally, the terminal device determines CSI feedback (for example, layer 1 reference signal received power (L1-RSRP) feedback or channel quality indication (CQI) feedback according to at least one of frequency domain resources, power parameters, and spatial domain parameters of the above CSI resources.

Optionally, the terminal device reports CSI feedback (for example, L1-RSRP feedback or CQI feedback) to the base station according to at least one of frequency domain resources, power parameters, and spatial domain parameters of the above CSI resources.

For the specific method of determining the CSI feedback or reporting the CSI feedback above, refer to the second embodiment described in detail below.

Advantageous Effects of Embodiment 1: Embodiment 1 provides a method for indicating CSI resources. The method can flexibly indicate the frequency domain resources, power parameters and spatial domain parameters corresponding to the CSI resources, thereby improving the performance of the communication system. Specifically, for SBFD, Embodiment 1 provides an indication method of CSI resources. This method considers the fact that the uplink and downlink directions corresponding to different frequency domain resources in the same time domain resource are different, and proposes an indication method of frequency domain resources, power parameters and spatial domain parameters of CSI resources, so as to improve the flexibility and accuracy of CSI resources indication. For network energy saving, Embodiment 1 provides an indication method of CSI resources. This method considers that the switching conditions/parameters corresponding to network energy saving of different time domain resources are different, and proposes an indication method of frequency domain resources, power parameters and spatial domain parameters of CSI resources, so as to improve the flexibility and accuracy of CSI resources indication.

### Embodiment 2 (CSI Reporting)

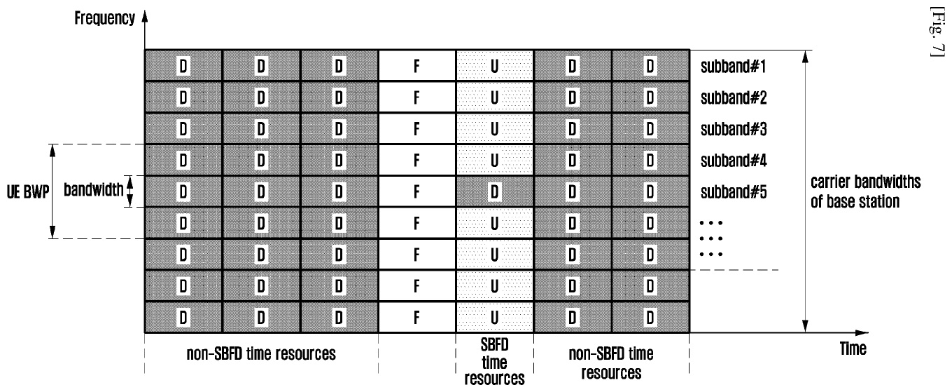

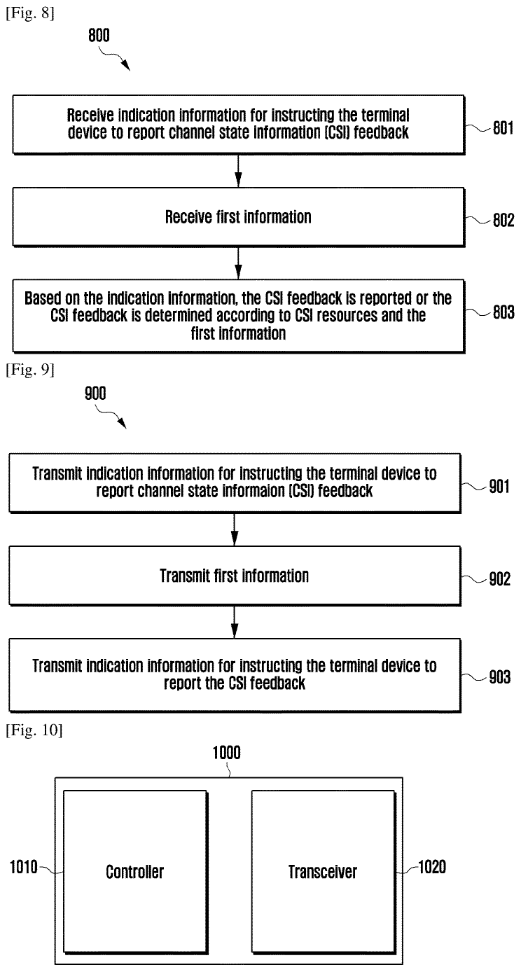

FIG. 8 illustrates another method 800 performed by a terminal device according to various embodiments of the present disclosure. As shown in FIG. 8, at 801, the terminal device receives indication information from the base station for indicating the terminal device to report channel state information (CSI) feedback; at 802, the terminal device receives first information from the base station, and the first information may be subband non-overlapping duplex (SBFD) information or network energy saving information; at 803, based on the indication information, CSI feedback is reported or CSI feedback is determined according to the CSI resources and the first information.

Here, the terminal device receives information indicating the terminal to report the CSI feedback. Optionally, the indication information is CSI report configuration information (for example, CSI-ReportConfig). Optionally, the CSI feedback is used for beam management. Optionally, the CSI feedback is L1-RSRP feedback or layer 1 signal-to-interference-to-noise ratio (L1-SINR) feedback or none (for example, the reporting quantity parameter reportQuantity in CSI-ReportConfig is set to one of ‘criRSRP’, ‘cri-SINR’, ‘ssb-Index-RSRP’, ‘ssb-Index-SINR’, ‘none’). Optionally, the CSI feedback is used for CSI acquisition. Optionally, the CSI feedback refers to the CQI feedback (for example, the report quantity parameter reportQuantity in CSI-ReportConfig is set to one of ‘cri-RI-PMI-CQI’, ‘cri-RI-i1’, ‘cri-RI-i1-CQI’, ‘cri-RI-CQI’, ‘cri-RI-LI-PMI-CQI’).

Here, for the explanation of the CSI resources, refer to Embodiment 1. Optionally, the CSI resources refer to the BWP of the terminal device.

Optionally, the frequency domain resources of the CSI resources (the frequency domain resources corresponding to the CSIs) is determined according to the CSI resource information from the base station. Here, refer to the first embodiment for the method of determining the frequency domain resources of the CSI resources according to the CSI resource information of the base station.

Here, the terminal device determines the CSI feedback according to the CSI resources and the first information. The method of determining the CSI feedback through the CSI resources is further discussed in the following examples.

### Example 1 (Determining Whether to Transmit the CSI Feedback According to CSI Resources and First Information)

The terminal device receives indication information; herein the indication information is to indicate the terminal device to report the CSI feedback; the terminal device also receives first information; herein the first information refers to SBFD information or network energy saving information; when the terminal device receives at least one CSI resource in the first time domain resources or non-first time domain resources, the terminal device reports the CSI feedback; otherwise, the terminal device drops the CSI feedback.

Here, the terminal device also receives the first information. In this disclosure, the first information refers to SBFD information or network energy saving information.

Optionally, the SBFD information may be understood as information related to SBFD (or used to indicate SBFD operations). Optionally, the SBFD information may be understood as information related to XDD (or used to indicate XDD operations).

Optionally, the network energy saving information refers to network state information. Here, the network can be understood as a network device. Specifically, the information indicates the state the network is at, for example, an on state, an off state, a normal state, and a sleep state.

Optionally, the network energy saving information refers to network mode information. Specifically, the information indicates the mode the network is in, for example, an on mode, an off mode, a normal mode, a sleep mode.

Optionally, the network energy saving information refers to network switch information. Specifically, the information indicates the switching state of the network, eg, on, off.

Here, the first information corresponding to the first time domain resource refers to at least one of the following:

Optionally, the first information corresponds to the SBFD time domain resources (or the first information indicates the SBFD time domain resources), which is called the first time domain resources. Optionally, the first time domain resources are downlink symbols (for example, downlink symbols indicated semi-statically by the base station. For another example, downlink symbols indicated semi-statically by the base station via common signaling). Optionally, the first time domain resources are uplink symbols (for example, uplink symbols indicated semi-statically by the base station. For another example, uplink symbols indicated semi-statically by the base station via common signaling). Optionally, the first time domain resources are uplink symbols (for example, uplink symbols indicated semi-statically by the base station. For another example, uplink symbols indicated semi-statically by the base station via common signaling). Optionally, the first time domain resource are flexible symbols (for example, flexible symbols indicated semi-statically by the base station. Another example, flexible symbols indicated semi-statically by the base station via common signaling).

Optionally, the first information corresponds to network energy saving time domain resources (or the first information indicates network energy saving time domain resources), and is called the first time domain resources. Optionally, the first time domain resources are time domain resources for which the network device is off (or in off mode, in off state). Optionally, the first time domain resources are time domain resources for which the network device is sleeping (or in a sleep mode, in a sleep state).

Here, the first information corresponding to the third frequency domain resource refers to at least one of the following:

Optionally, the first information corresponds to SBFD frequency domain resources, which are called third frequency domain resources. Optionally, the third frequency domain resources corresponds to the starting RB (for example,

$${N}_{S B F D}^{s t a r t} ,$$

optionally, the value of the starting RB is a multiple of 4) and/or the number of RBs (for example,

$${N}_{S BFD}^{s i z e} ,$$

optionally, the value of the number of RBs is a multiple of 4).

Optionally, the first information corresponds to network energy-saving frequency domain resources, which are referred to as third frequency domain resources. Optionally, the third frequency domain resources corresponds to the starting RB (for example,

$${N}_{NES}^{s t a r t} ,$$

optionally, the value of the starting RB is a multiple of 4) and/or the number of RBs (for example,

$${N}_{NES}^{s i z e} ,$$

optionally, the value of the number of RBs is a multiple of 4). Optionally, the third frequency domain resources correspond to one or more cells or component carriers (CCs). Optionally, the third frequency domain resources are frequency domain resources for which the network device is off (or in a off mode, in a off state). Optionally, the third frequency domain resources are frequency domain resources where the network device is sleeping (or in a sleep mode, in a sleep state).

Optionally, the CSI resources are in the first time domain resources corresponding to the first information.

Optionally, the CSI resources are not in the first time domain resources corresponding to the first information.

Optionally, the CSI resources are in Discontinuous Reception (DRX) Active Time.

Optionally, the CSI resources are no later than the CSI reference resources.

Optionally, CSI resources refer to CSI-RS transmission occasions for channel measurement and CSI-RSs and/or CSI-IM occasions for interference measurement).

Optionally, there are the following methods for determining whether to transmit the CSI feedback according to the CSI resources and the first information:

### Method 1

The terminal device also receives first information; herein the first information refers to SBFD information or network energy saving information; when the terminal device receives at least one CSI resource in the first time domain resources corresponding to the first information, the terminal device reports CSI feedback; otherwise, the terminal device drops the CSI feedback.

Optionally, the CSI resources are in the first time domain resources corresponding to the first information.

Optionally, at least one CSI resource is not later than the CSI reference resources.

That is, when the terminal device receives at least one CSI resource that is not later than the CSI reference resources and is in the first time domain resources corresponding to the first information, the terminal device reports the CSI feedback; otherwise, the terminal device drops the CSI feedback. Here, the CSI resources refer to CSI-RS transmission occasions for channel measurement and CSI-RS and CSI-IM occasions for interference measurement.

### Method 2

The terminal device also receives first information; herein, the first information refers to SBFD information or network energy saving information; when the terminal device receives at least one CSI resource not in the first time domain resources corresponding to the first information, the terminal device reports the CSI feedback; otherwise, the terminal device drops the CSI feedback.

Optionally, the CSI resources is not in the first time domain resources corresponding to the first information.

Optionally, the CSI resources are no later than the CSI reference resource.

That is, when the terminal device receives at least one CSI resource that is not later than the CSI reference resource and is not in the first time domain resources corresponding to the first information, the terminal device reports the CSI feedback; otherwise, the terminal device drops the CSI feedback. Here, the CSI resources refer to CSI-RS transmission occasions for channel measurement and CSI-RS and CSI-IM occasions for interference measurement.

### Method 3

The terminal device also receives first information; herein the first information refers to SBFD information or network energy saving information; when the terminal device receives at least one CSI resource in the first time domain resources corresponding to the first information, the terminal device reports the CSI feedback; otherwise, the terminal device drops the CSI feedback.

Optionally, the CSI resources are in the first time domain resources corresponding to the first information.

Optionally, the CSI resources are in DRX active time.

Optionally, the CSI resources are no later than the CSI reference resources.

That is, when the terminal device receives at least one CSI resource that is not later than the CSI reference resources and is in the first time domain resources corresponding to the first information and is also in the DRX active time, the terminal device reports the CSI feedback; otherwise, the terminal device drops the CSI feedback. Here, the CSI resources refer to CSI-RS transmission occasions for channel measurement and CSI-RS and CSI-IM occasions for interference measurement.

Optionally, the terminal device is configured with DRX.

### Method 4

The terminal device also receives first information; herein, the first information refers to SBFD information or network energy saving information; when the terminal device receives at least one CSI resource not in the first time domain resources corresponding to the first information, the terminal device reports the CSI Feedback; otherwise, the terminal device drops the CSI feedback.

Optionally, the CSI resources are not in the first time domain resources corresponding to the first information.

Optionally, the CSI resources are in DRX active time.

Optionally, at least one CSI resource is not later than the CSI reference resources.

That is, when the terminal device receives at least one CSI resource that is no later than the CSI reference resources and is not in the first time domain resources corresponding to the first information and is in the DRX active time, the terminal device reports the CSI feedback; otherwise, the terminal device drops the CSI feedback. Here, the CSI resources refer to CSI-RS transmission occasions for channel measurement and CSI-RS and CSI-IM occasions for interference measurement.

Optionally, the CSI resources is in DRX active time.

### Method 5

The terminal device also receives first information; herein the first information refers to SBFD information or network energy saving information; in the first time domain resources, when the frequency domain resources corresponding to the CSI resources are greater than (or greater than or equal to) the value indicated by the base station or a predefined value, the terminal device reports the CSI feedback; otherwise, the terminal device drops the CSI feedback.

Optionally, on the first time domain resources, the method for determining the frequency domain resources corresponding to the CSI resources refer to Example 1-1 or 1-2 in Embodiment 1.

Optionally, the base station indicates that the corresponding signaling is at least one of radio resource control (RRC), medium access control (MAC), and downlink control information (DCI).

Optionally, the predefined values are, for example, 0, 24 RBs, 48 RBs and so on.

### Method 6

The terminal device also receives first information; herein, the first information refers to SBFD information or network energy saving information; when the frequency domain resources of the BWP of the terminal device are included in the third frequency domain resources corresponding to the first information, the terminal device reports the CSI feedback; otherwise, the terminal device drops the CSI feedback.

Optionally, the base station indicates that the corresponding signaling is at least one of RRC, MAC, and DCI.

### Method 7

The terminal device also receives first information; herein, the first information refers to SBFD information or network energy saving information; the CSI feedback corresponds to two resource groups (or, two resource groups and at least one resource pair); when the terminal device receives at least one CSI resource in the first time domain resources corresponding to the first information, the terminal device reports the CSI feedback; otherwise, the terminal device drops the CSI feedback.

Optionally, the CSI resources refer to one resource pair. Specifically, it refers to two/each CSI resources in one resource pair.

Optionally, the CSI resources are in the first time domain resources corresponding to the first information.

Optionally, at least one CSI resource is not later than the CSI reference resources.

That is, when the terminal device receives at least one resource pair that is not later than the CSI reference resources and is in the first time domain resources corresponding to the first information, the terminal device reports the CSI feedback; otherwise, the terminal device drops CSI feedback.

### Method 8

The terminal device also receives first information; herein, the first information refers to SBFD information or network energy saving information; the CSI feedback corresponds to two resource groups (or, two resource groups and at least one resource pair); when the terminal device receives at least one CSI resource not in a first time domain resources corresponding to the first information, the terminal device reports the CSI feedback; otherwise, the terminal device drops the CSI feedback.

Optionally, the CSI resources refer to one resource pair. Specifically, it refers to two/each CSI resources in one resource pair.

Optionally, the CSI resources are not in the first time domain resources corresponding to the first information.

Optionally, at least one CSI resource is not later than the CSI reference resources.

That is, when the terminal device receives at least one resource pair that is no later than the CSI reference resources and is not in the first time domain resources corresponding to the first information, the terminal device reports the CSI feedback; otherwise, the terminal device drops CSI Feedback.

### Method 9

The terminal device also receives first information; herein, the first information refers to SBFD information or network energy saving information; the CSI feedback corresponds to two resource groups (or, two resource groups and at least one resource pair); when the terminal device receives at least one CSI resource in the first time domain resources corresponding to the first information, the terminal device reports the CSI feedback; otherwise, the terminal device drops the CSI feedback.

Optionally, the CSI resources refer to one resource pair. Optionally, two/each CSI resources in one resource pair.

Optionally, the CSI resources are in the first time domain resources corresponding to the first information.

Optionally, the CSI resources are in DRX active time.

Optionally, at least one CSI resource is no later than the CSI reference resources.

That is, when the terminal device receives at least one resource pair that is no later than the CSI reference resources and is in the first time domain resources corresponding to the first information and also in the DRX active time, the terminal device reports the CSI feedback; otherwise, the terminal device drops the CSI feedback.

### Method 10

The terminal device also receives first information; herein, the first information refers to SBFD information or network energy saving information; the CSI feedback corresponds to two resource groups (or, two resource groups and at least one resource pair); when the terminal device receives at least one CSI resource not in the first time domain resources corresponding to the first information, the terminal device reports the CSI feedback; otherwise, the terminal device drops the CSI feedback.

Optionally, the CSI resources refer to one resource pair. Specifically, it refers to two/each CSI resources in one resource pair.

Optionally, the CSI resources are not in the first time domain resources corresponding to the first information.

Optionally, the CSI resources are in DRX active time.

Optionally, at least one CSI resource is no later than the CSI reference resources.

That is, when the terminal device receives at least one resource pair that is no later than the CSI reference resource and is not in the first time domain resources corresponding to the first information and is also in the DRX active time, the terminal device reports the CSI feedback; otherwise, the terminal device drops the CSI feedback.

### Example 2 (Determining CSI Feedback According to CSI Resources and First Time Domain Resources)

The terminal device receives indication information; herein the indication information is to indicate the terminal device to report the CSI feedback; the terminal device also receives first information; herein the first information refers to SBFD information or network energy-saving information; the terminal device determines the CSI feedback according to the CSI resources and the first time domain resources corresponding to the first information.

Here, refer to Example 1 for the description of the first information, the first time domain information, the first time domain resources, and the third frequency domain resources.

Specifically, the terminal device determines the CSI feedback according to the CSI resources and the first information in the following ways:

### Method 1

The terminal device determines the CSI feedback according to the CSI resources in the first time domain resources.

For example, the terminal device determines/derives the reported channel measurements for computing L1-RSRP according to CSI resources (for example, SSB or CSI-RS) that are no later than CSI reference resources. Optionally, CSI resources refer to CSI resources in the first time domain resources (for example, SSB or CSI-RS; for example, SSB or CSI-RS occasion).

For another example, the terminal device determines/derives the reported channel measurements for computing L1-RSRP according to the latest CSI resources (for example, SSB or CSI-RS) that is no later than the CSI reference resources. Optionally, the CSI resources refer to CSI resources in the first time domain resources (for example, SSB or CSI-RS; for example, SSB or CSI-RS occasion).

For another example, the terminal device determines/derives the reported channel measurements for computing L1-SINR according to the CSI resources (for example, SSB or CSI-RS) that is no later than the CSI reference resources. Optionally, the CSI resources refer to CSI resources in the first time domain resources (for example, SSB or CSI-RS; for example, SSB or CSI-RS occasion).

For another example, the terminal device determines/derives the reported channel measurements for computing L1-SINR according to the latest CSI resources (for example, SSB or CSI-RS) that is no later than the CSI reference resources. Optionally, the CSI resources refer to CSI resources in the first time domain resources (for example, SSB or CSI-RS; for example, SSB or CSI-RS occasion).

For another example, the terminal device determines/derives the reported interference measurements for computing L1-SINR according to the CSI resources (for example, SSB or CSI-RS) that is no later than the CSI reference resources. Optionally, the CSI resources refer to CSI resources in the first time domain resources (for example, CSI-IM or NZP CSI-RS for interference measurement; occasions of CSI-IM or NZP CSI-RS for interference measurement).

For another example, the terminal device determines/derives the reported interference measurements for computing L1-SINR according to the latest CSI resources (for example, SSB or CSI-RS) that is no later than the CSI reference resources. Optionally, the CSI resources refer to CSI resources in the first time domain resources (for example, CSI-IM or NZP CSI-RS for interference measurement; occasions of CSI-IM or NZP CSI-RS for interference measurement).

Optionally, the base station indicates the terminal device to use one or more of the methods listed in each example described in the first method through RRC/MAC-CE signaling.

Optionally, the terminal device determines to use one or more of the methods listed in each example described in the Method 1 through predefined rules.

### Method 2

The terminal device determines the CSI feedback according to CSI resources that are not in the first time domain resources.

For example, the terminal device determines/derives the reported channel measurements for computing L1-RSRP according to CSI resources (for example, SSB or CSI-RS) no later than CSI reference resources. Optionally, CSI resources refer to CSI resources that are not in the first time domain resources (for example, SSB or CSI-RS; for example, SSB or CSI-RS occasion).

For another example, the terminal device determines/derives the reported channel measurements for computing L1-RSRP according to the latest CSI resources (for example, SSB or CSI-RS) no later than CSI reference resources. Optionally, the CSI resources refer to CSI resources not in the first time domain resources (for example, SSB or CSI-RS; for example, SSB or CSI-RS occasion).

For another example, the terminal device determines/derives the reported channel measurements for computing L1-SINR according to the CSI resources (for example, SSB or CSI-RS) no later than CSI reference resources. Optionally, the CSI resources refer to CSI resources not in the first time domain resources (for example, SSB or CSI-RS; for example, SSB or CSI-RS occasion).

For another example, the terminal device determines/derives the reported channel measurements for computing L1-SINR according to the latest CSI resources (for example, SSB or CSI-RS) no later than CSI reference resources. Optionally, the CSI resources refer to CSI resources not in the first time domain resources (for example, SSB or CSI-RS; for example, SSB or CSI-RS occasion).

For another example, the terminal device determines/derives the reported interference measurements for computing L1-SINR according to the CSI resources (for example, SSB or CSI-RS) no later than CSI reference resources. Optionally, the CSI resources refer to CSI resources not in the first time domain resources (for example, CSI-IM or NZP CSI-RS for interference measurement; for example, occasions of CSI-IM or NZP CSI-RS for interference measurement).

For another example, the terminal device determines/derives the reported interference measurements for computing L1-SINR according to the latest CSI resources (for example, SSB or CSI-RS) no later than CSI reference resources. Optionally, the CSI resources refer to CSI resources not in the first time domain resources (for example, CSI-IM or NZP CSI-RS for interference measurement; for example, occasions of CSI-IM or NZP CSI-RS for interference measurement).

Optionally, the base station indicates the terminal device to use one or more of the methods listed in each example described in Method 2 through RRC/MAC-CE signaling.

Optionally, the terminal device determines to use one or more of the methods listed in each example described in Method 2 through a predefined rule.

### Method 3

The terminal device determines the CSI feedback according to the CSI resources in the first time domain resources and the CSI resources not in the first time domain resources; Optionally, the terminal device determines the CSI feedback according to the first power parameter. Here, the first power parameter refers to the power parameter corresponding to CSI resources in the first time domain resources. See Example 2-1 and Example 2-2 of Embodiment 1 for the first power parameter.

### Method 4

The CSI resources includes a first CSI feedback and a second CSI feedback; The terminal device determines a first CSI feedback according to CSI resources in first time domain resources; the terminal device determines a second CSI feedback according to the CSI resources that are not in the first time domain resources.

Here, the implementation of Method 4 refers to Method 1 and Method 2. Specifically, the method for determining the first CSI feedback is the same as Method 1; the method for determining the second CSI feedback is the same as Method 2.

Optionally, the terminal device determines to perform at least one of the foregoing methods according to an instruction of the base station or a predefined rule. For example, the signaling indicated by the base station is RRC, MAC-CE or DCI. For example, the default method is Method 1. In other words, when the terminal device receives the first information, the default method is Method 1.

### Example 3 (Determining the CSI Feedback Based on CSI Resources and Third Frequency Domain Resources)

The terminal device receives indication information; herein the indication information is to indicate the terminal device to report the CSI feedback; the terminal device also receives first information; herein the first information refers to SBFD information or network energy saving information; the terminal device determines the CSI feedback according to the BWP of the terminal device and/or the third frequency domain resources corresponding to the first information.

Here, refer to Example 1 for descriptions of the first information, the first time domain information, the first time domain resources, and the third frequency domain resources.

Optionally, the terminal device determines subband parameters corresponding to the CSI feedback according to the BWP and the third frequency domain resources.

Optionally, the subband parameters refer to the size of subband. Specifically, the determination method of the subband is as follow:

### Method 1

The size of the subband is determined according to the frequency domain resources corresponding to BWP subtracted by the third frequency domain resources.

Optionally, the third frequency domain resource is included in the frequency domain resource corresponding to the BWP. For example, the starting RB of the BWP is less than or equal to the starting RB of the third frequency domain resources; and, the ending RB of the BWP is greater than or equal to the ending RB of the third frequency domain resources.

Optionally, the frequency domain resource corresponding to BWP that subtracted by the third frequency domain resource refers to the frequency domain resources corresponding to BWP that subtracted to a part of the third frequency domain resources. Optionally, a part of the third frequency domain resource refers to the intersection of the third frequency domain resource and the frequency domain resource corresponding to the BWP.

A specific example is as follows. The terminal device to determine the configurable subband size according to the following table. For different bandwidths, there are two subband size values.

| Frequency domain resources corresponding | |
|---|---|
| to BWP that subtracted by the third | Subband |
| frequency domain resource (PRB) | Size (PRB) |
| 24-72 | 4, 8 |
| 73-144 | 8, 16 |
| 145-275 | 16, 32 |

Further, the terminal device receives indication information from the base station (for example, the subband size indicates information subbandSize in CSI-ReportConfig). The indication corresponds to value 1 and value 2, herein value 1 is used to indicate the value of the size of the first subband; value 2 is used to indicate the value of the size of the second subband.

Optionally, for the case where the first time domain resources are downlink symbols (for example, the downlink symbols indicated semi-statically by the base station. For another example, the downlink symbols indicated semi-statically by the base station via common signaling), on the first time domain resources, Method 1 above is performed to determine the subband size of the CSI.

### Method 2

The subband size is determined according to the third frequency domain resources.

Optionally, the third frequency domain resources refer to a part of the third frequency domain resources. Specifically, a part of the third frequency domain resource refers to the intersection of the third frequency domain resources and the frequency domain resources corresponding to the BWP.

A specific example is as follows, the terminal device refers to the following table to determine the configurable subband size. For different bandwidths, there are two subband size values.

| Third frequency domain resources | Subband |
|---|---|
| bandwidth (PRB) | Size (PRBs) |
| 24-72 | 4, 8 |
| 73-144 | 8, 16 |
| 145-275 | 16, 32 |

Further, the terminal device receives indication information from the base station (for example, the subband size indicates information subbandSize in CSI-ReportConfig). The indication corresponds to value 1 and value 2, herein value 1 is used to indicate the value of the size of the first subband; value 2 is used to indicate the value of the size of the second subband.

Optionally, for the case where the first time domain resources are downlink symbols (for example, the downlink symbols indicated semi-statically by the base station. For another example, the downlink symbols indicated semi-statically by the base station via common signaling), on the first time domain resources, the Method 2 above is performed to determine the subband size of the CSIs.

### Method 3

The subband size is determined according to the size of a part of the BWP. Herein, the part of the BWP refers to frequency domain resource in the BWP that do not overlap with the third frequency domain resource. In other words, the part of the BWP refers to the frequency domain resources in the BWP excluding the overlapping part with the third frequency domain resources. In other words, the part of the BWP is determined by the difference between the BWP and the overlapping part of the BWP and the third frequency domain resources.

The following example illustrates how a part of the BWP is determined. For example, the frequency domain resources corresponding to the BWP are PRB #8 to PRB #50; the frequency domain resources corresponding to the third frequency domain part are PRB #45 to PRB #75. It can be seen that, in this example, the overlapping parts of the BWP and the third frequency domain resources are PRB #45 to PRB #50. Therefore, a part of the BWP is the part of BWP which do not include PRB #45 to PRB #50, that is, PRB #8 to PRB #44.

Further, the terminal device determines the size of the subbands according to the size of the part of the BWP. The specific method is shown in the table below. According to the above example, a part of the BWP corresponds to PRB #8 to PRB #44. That is, the size of a part of the BWP is 37 PRBs. According to the table, it can be seen that the size of a part of the BWP corresponds to a subband size of 4 PRBs or 8 PRBs.

| A Part of BWP (PRB) | Subband Size (PRBs) |
|---|---|
| 24-72 | 4, 8 |
| 73-144 | 8, 16 |
| 145-275 | 16, 32 |

Further, the terminal device receives indication information from the base station (for example, the subband size indicates information subbandSize in CSI-ReportConfig). The indication corresponds to value 1 and value 2, herein value 1 is used to indicate the value of the size of the first subband (For example, 4 PRBs in the above example); value 2 is used to indicate the value of the size of the second subband (for example, 8 PRBs in the example above).

Optionally, for the case where the first time domain resources are downlink symbols (for example, the downlink symbols indicated semi-statically by the base station. For another example, the downlink symbols indicated semi-statically by the base station via common signaling), on the first time domain resources, the method above is performed to determine the subband size corresponding to the CSI feedback.

### Method 4

The subband size is determined according to the size of a part of the BWP. Herein, the part of the BWP refers to frequency domain resources in the BWP that neither overlaps with the third frequency domain resources nor overlaps with a guardband. In other words, the part of the BWP refers to the frequency domain resources in the BWP excluding the overlapping part with the third frequency domain resources and the overlapping part with the guardband. Optionally, the guardband is associated with SBFD operations or network energy saving. Optionally, the guardband is associated with the third frequency domain resources.

The following example illustrates how a part of the BWP are determined. For example, the frequency domain resources corresponding to the BWP are PRB #8 to PRB #50; the frequency domain resources corresponding to the third frequency domain resources are PRB #45 to PRB #75. Here, the guardband is on both sides of the third frequency domain resources, and has a size of 2 PRBs. That is, the guardband corresponds to PRB #43, PRB #44, PRB #76 and PRB #77. It can be seen that, in this example, the overlapping parts of the BWP and the third frequency domain resources are PRB #45 to PRB #50; the overlapping parts of the BWP and the guardband are PRB #43 and PRB #44. Therefore, a part of the BWP is the part of BWP which do not include PRB #43 to PRB #50, that is, PRB #8 to PRB #42.

Optionally, the terminal device determines the size of the subbands according to the size of a part of the BWP. The specific method is shown in the table below. According to the above example, a part of the BWP corresponds to PRB #8 to PRB #42. That is, the size of a part of the BWP is 35 PRBs. According to the table, it can be seen that the size of a part of the BWP corresponds to a subband size of 4 PRBs or 8 PRBs.

| A Part of BWP (PRB) | Subband Size (PRBs) |
|---|---|
| 24-72 | 4, 8 |
| 73-144 | 8, 16 |
| 145-275 | 16, 32 |

Optionally, the terminal device receives indication information from the base station (for example, the subband size indicates information subbandSize in CSI-ReportConfig). The indication corresponds to value 1 and value 2, herein value 1 is used to indicate the value of the size of the first subband (For example, 4 PRBs in the above example); value 2 is used to indicate the value of the size of the second subband (for example, 8 PRBs in the example above).

Optionally, for the case where the first time domain resources are downlink symbols (for example, the downlink symbols indicated semi-statically by the base station. For another example, the downlink symbols indicated semi-statically by the base station via common signaling), on the first time domain resources, the method above is performed to determine the subband size corresponding to the CSI feedback.

### Method 5

The subband size is determined according to the size of a part of the BWP. Herein, the part of the BWP refers to the frequency domain resources overlapping with the third frequency domain resources in the BWP.

The following example illustrates how a part of the BWP is determined. For example, the frequency domain resources corresponding to the BWP are PRB #8 to PRB #50; the frequency domain resources corresponding to the third frequency domain part are PRB #25 to PRB #75. It can be seen that, in this example, the overlapping parts of the BWP and the third frequency domain resources are PRB #25 to PRB #50. Therefore, a part of the BWP is PRB #25 to PRB #50.

Further, the terminal device determines the size of the subbands according to the size of a part of the BWP. The specific method is shown in the table below. According to the above example, a part of the BWP corresponds to PRB #25 to PRB #50. That is, the size of a part of the BWP is 26 PRBs. According to the table, it can be seen that the size of a part of the BWP corresponds to a subband size of 4 PRBs or 8 PRBs.

| A Part of BWP (PRB) | Subband Size (PRBs) |
|---|---|
| 24-72 | 4, 8 |
| 73-144 | 8, 16 |
| 145-275 | 16, 32 |

Further, the terminal device receives indication information from the base station (for example, the subband size indicates information subbandSize in CSI-ReportConfig). The indication corresponds to value 1 and value 2, herein value 1 is used to indicate the value of the size of the first subband (For example, 4 PRBs in the above example); value 2 is used to indicate the value of the size of the second subband (for example, 8 PRBs in the example above).

Optionally, for the case where the first time domain resources are uplink symbols (for example, the uplink symbols indicated semi-statically by the base station. For another example, the uplink symbols indicated semi-statically by the base station via common signaling), on the first time domain resources, the method above is performed to determine the subband size of the CSI.

### Example 4 (Determining the CSI Feedback According to CSI Reference Resources and First Information)

The terminal device receives indication information; herein the indication information is to indicate the terminal device to report the CSI feedback; the terminal device also receives first information; herein the first information refers to SBFD information or network energy saving information; in the CSI reference resources, the terminal device determines the CSI feedback according to at least one of the following: a first power parameter; a second power parameter; a first spatial parameter; a second spatial parameter.

Optionally, the CSI feedback refers to at least one of a CQI feedback, a precoding matrix indication (PMI) feedback, and a rank indication (RI) feedback.

Optionally, the CSI feedback refers to at least one of a L1-RSRP feedback and a L1-SINR feedback.

Here, for the methods for determining the first power parameter, the second power parameter, the first spatial domain parameter, and the second spatial domain parameter, refer to Embodiment 1.

Optionally, the CSI reference resources are in the first time domain resources corresponding to the first information. Herein, the explanation of the first time domain resource refers to Example 1. Specifically, if the CSI reference resources are in the first time domain resources, the terminal device determines the CSI feedback according to the second power parameter and/or the second spatial domain parameter.

Optionally, the CSI reference resources are not in the first time domain resources corresponding to the first information. Here, the explanation of the first time domain resources refer to Example 1. Specifically, if the CSI reference resources are not in the first time domain resources, the terminal device determines the CSI feedback according to the first power parameter and/or the first space domain parameter.

### Example 5 (Determining CSI Feedback According to CSI Reference Resources and First Information)

The terminal device receives indication information; herein the indication information is used to indicate the terminal device to report the CSI feedback; the terminal device also receives first information; herein the first information refers to SBFD information or network energy saving information; in the CSI reference resources, the CSI feedback is determined according to parameters of the terminal device. Optionally, the CSI reference signal resources are in an valid downlink time slot. Herein, the valid downlink time slot refers to at least one of the following: the valid downlink time slot includes at least one symbol in the first time domain resources corresponding to the first information; the valid downlink time slot includes at least one downlink or flexible symbol configured by the high layer; Herein, the downlink or flexible symbol is not in the first time domain resources corresponding to the first information; the valid downlink time slot includes at least one uplink symbols configured by the high layer; herein, the uplink symbols is in the first time domain resources corresponding to the first information; the valid downlink time slot is not in the configured measurement gaps of the terminal device.

Specifically, the method for determining a valid downlink time slot is as follows:

### Method 1

The valid downlink time slot includes at least one of the following: at least one symbol in the first time domain resource corresponding to the first information (for example, the first time domain resource correspond to downlink or flexible symbols; for another example, the first time domain resource correspond to the downlink or flexible symbols indicated by high-level signaling or RRC signaling); first time domain resource corresponding to the first information, where there are frequency domain resource for downlink transmission (for example, on the first time domain resources, not all the frequency domain resource of the BWP corresponding to the terminal device correspond to the uplink); is not in the configured measurement gap of the terminal device.

### Method 2

The valid downlink time slot includes at least one of the following: at least one symbol in the first time domain resource corresponding to the first information (for example, the first time domain resource correspond to uplink or flexible symbols; for another example, the first time domain resource correspond to the uplink or flexible symbols indicated by high-level signaling or RRC signaling); first time domain resource corresponding to the first information, where there are frequency domain resources for downlink transmission (for example, on the first time domain resource, not all the frequency domain resource of the BWP corresponding to the terminal device correspond to the uplink); is not in the configured measurement gap of the terminal device.

### Method 3

A valid downlink time slot includes at least one of the following: downlink or flexible symbols indicated by high-level signaling; optionally, the downlink or flexible symbols are not in the first time domain resources corresponding to the first information; is not among the configured measurement gap of the terminal device.

### Example 6 (Determining Whether CSI Feedback Corresponds to a Wideband Granularity According to BWP and/or Third Frequency Domain Resources)

The terminal device receives indication information; herein the indication information is to indicate the terminal device to report the CSI feedback; the terminal device also receives first information; herein the first information refers to SBFD information or network energy saving information; the terminal device determines the CSI feedback according to BWP of the terminal device and/or the third frequency domain resources corresponding to the first information.

Here, for the description of the first information, the first time domain information, the first time domain resources, and the third frequency domain resources, refer to Example 1 of Embodiment 2. Optionally, the CSI feedback refers to the CSI feedback for the BWP.

Optionally, the terminal device determining the CSI feedback according to the BWP and/or the third frequency domain resources means that the terminal device determines whether the CSI feedback corresponds to a wideband granularity according to the BWP and/or the third frequency domain resources.

The CSI feedback is usually performed on one frequency domain resource. For this frequency domain resource, there are generally two frequency domain granularities of the CSI feedback, a wideband granularity and a subband granularity (also called a wideband CSI feedback and a subband CSI feedback). The wideband CSI feedback means that the CSI feedback is CSI feedback performed on the entire frequency domain resource. The subband CSI feedback means that the CSI feedback is the CSI feedback performed on the subbands of the frequency domain resources respectively.

Specifically, determining whether the CSI feedback corresponds to the wideband granularity is as follows:

### Method 1

If a part of the BWP is less than (or, less than or equal to) one threshold, the terminal device determines that the CSI feedback corresponds to a wideband granularity. Herein, the part of the BWP refers to frequency domain resources in the BWP that do not overlap with the third frequency domain resources. In other words, the part of the BWP refers to the frequency domain resources in the BWP excluding the overlapping part with the third frequency domain resource. In other words, the part of the BWP is determined by the difference between the BWP and the overlapping part of the BWP and the third frequency domain resources. Optionally, the threshold is one of 12 PRBs, 24 PRBs, 36 PRBs and so on.

The following example illustrates how a part of the BWP are determined. For example, the frequency domain resources corresponding to the BWP are PRB #8 to PRB #20; the frequency domain resources corresponding to the third frequency domain part are PRB #15 to PRB #25. It can be seen that, in this example, the overlapping part of the BWP and the third frequency domain resources are PRB #15 to PRB #20. Therefore, a part of the BWP is the part of BWP which do not include PRB #15 to PRB #20, that is, PRB #8 to PRB #14. Further, a part of the BWP needs to be compared with one threshold. In this example, the threshold takes 24 PRBs as an example. The part of the BWP is PRB #8 to PRB #14, that is, 7 PRBs. Since the 7 PRBs are smaller than the threshold of 24 PRBs, it can be determined that the CSI feedback corresponds to the wideband granularity.

Optionally, when a part of the above BWP is greater than (or greater than or equal to) the threshold, the CSI feedback corresponds to the subband granularity. Refer to Example 3 for the determination method of subband parameters.

Optionally, when a part of the above BWP is greater than (or greater than or equal to) the threshold, the frequency domain granularity corresponding to the CSI feedback is indicated by the base station. When the base station indicates that the CSI feedback corresponds to the subband granularity, refer to Example 3 for the method for determining the subband parameters.

Optionally, for the case where the first time domain resources are downlink symbols (for example, the downlink symbols indicated semi-statically by the base station. For another example, the downlink symbols indicated semi-statically by the base station via common signaling), on the first time domain resources, the above method is performed to determine the bandwidth granularity corresponding to the CSI feedback.

### Method 2

If a part of the BWP is less than (or, less than or equal to) a threshold, the terminal device determines that the CSI feedback corresponds to a wideband granularity. Herein, the part of the BWP refers to a frequency domain resources in the BWP that neither overlaps with the third frequency domain resources nor overlaps with a guardband. In other words, the part of the BWP refers to the frequency domain resources in the BWP excluding the overlapping part with the third frequency domain resources and the overlapping part with the guardband. Optionally, the threshold is one of 12 PRBs, 24 PRBs, 36 PRBs and so on. Optionally, the guardband is associated with SBFD operation or network energy saving. Optionally, the guardband is associated with the third frequency domain resources.

The following example illustrates how a part of the BWP are determined. For example, the frequency domain resources corresponding to the BWP are PRB #8 to PRB #20; the frequency domain resources corresponding to the third frequency domain resources are PRB #15 to PRB #25. Here, the guardband is on both sides of the third frequency domain resources, and has a size of 2 PRBs. That is, the guardband corresponds to PRB #13, PRB #14, PRB #26 and PRB #27. It can be seen that, in this example, the overlapping parts of the BWP and the third frequency domain resources are PRB #15 to PRB #20; the overlapping part of the BWP and the guardband are PRB #13 and PRB #14. Therefore, a part of the BWP is the part of BWP which do not include PRB #13 to PRB #20, that is, PRB #8 to PRB #12. Further, a part of the BWP needs to be compared with a threshold. In this example, the threshold takes 24 PRBs as an example. A part of the BWP is PRB #8 to PRB #12, that is, 5 PRBs. Since 5 PRBs are smaller than the threshold of 24 PRBs, it can be determined that the CSI feedback corresponds to a wideband granularity.

Optionally, when a part of the BWP is greater than (or greater than or equal to) the threshold, the CSI feedback corresponds to the subband granularity. Refer to Example 3 for the determination method of subband parameters.

Optionally, when a part of the BWP is greater than (or greater than or equal to) the threshold, the frequency domain granularity corresponding to the CSI feedback is indicated by the base station. When the base station indicates that the CSI feedback corresponds to the subband granularity, refer to Example 3 for the method for determining the subband parameters.

Optionally, for the case where the first time domain resources are downlink symbols (for example, the downlink symbols indicated semi-statically by the base station. For another example, the downlink symbols indicated semi-statically by the base station via common signaling), on the first time domain resources, the above method is performed to determine the bandwidth granularity corresponding to the CSI feedback.

### Method 3

If a part of the BWP is less than (or less than or equal to) a threshold, the terminal device determines that the CSI feedback corresponds to a wideband granularity. Herein, the part of the BWP refers to the frequency domain resources in the BWP overlapping with the third frequency domain resources. Optionally, the threshold is 12 PRBs, 24 PRBs, 36 PRBs and so on.

The following example illustrates how a part of the BWP are determined. For example, the frequency domain resources corresponding to the BWP are PRB #8 to PRB #20; the frequency domain resources corresponding to the third frequency domain part are PRB #15 to PRB #25. It can be seen that, in this example, the overlapping parts of the BWP and the third frequency domain resources are PRB #15 to PRB #20. Therefore, a part of the BWP is PRB #15 to PRB #20. Further, a part of the BWP needs to be compared with a threshold. In this example, the threshold takes 24 PRBs as an example. Part of the BWP is PRB #15 to PRB #20, that is, 6 PRBs. Since 6 PRBs are smaller than the threshold of 24 PRBs, it can be determined that the CSI feedback corresponds to the wideband granularity.

Optionally, when a part of the BWP is greater than (or greater than or equal to) the threshold, the CSI feedback corresponds to the subband granularity. Refer to Example 3 for the determination method of subband parameters.

Optionally, when a part of the BWP is greater than (or greater than or equal to) the threshold, the frequency domain granularity corresponding to the CSI feedback is indicated by the base station. When the base station indicates that the CSI feedback corresponds to the subband granularity, refer to Example 3 for the method for determining the subband parameters.

Optionally, for the case where the first time domain resources are uplink symbols (for example, the uplink symbols indicated semi-statically by the base station. Another example, the uplink symbols indicated semi-statically by the base station via common signaling), on the first time domain resources, the above method is performed to determine the subband size of the CSI.

Benefit of Example 6: this example provides a method for determining the frequency domain granularity of the CSI feedback. The method can determine the frequency domain granularity corresponding to the CSI feedback according to the relationship between the frequency domain resource corresponding to the SBFD information or the network energy saving information and the BWP when the terminal device receives the SBFD information or the network energy saving information. In the scenario of SBFD or network energy saving, not all frequency domain resources in a BWP can be used for downlink scheduling, and the corresponding available frequency domain resources (for example, a part of BWP) need to be determined according to the SBFD or network energy saving indication information. According to this method, the terminal device determines the CSI feedback frequency domain granularity according to the valid part of the BWP, which can improve the accuracy of the CSI feedback.

Benefit of Embodiment 2: Embodiment 2 provides a method for obtaining the CSI feedback. The method can correctly generate the CSI feedback when the terminal device receives SBFD information or network energy saving information, thereby improving the performance of the communication system. Specifically, for SBFD, Embodiment 2 provides a method for CSI feedback, which considers the fact that the uplink and downlink directions corresponding to different frequency domain resources in the same time domain resource are different, and proposes a method for the terminal device to perform the CSI feedback, in order to improve the flexibility and accuracy of the CSI feedback. For network energy saving, Embodiment 2 provides a method for performing CSI feedback. This method considers that the switching conditions/parameters corresponding to network energy saving of different time domain resources are different, and proposes a method for terminal device to perform the CSI feedback, in order to improve the flexibility and accuracy of the CSI feedback.

FIG. 9 illustrates a method 900 performed by a base station according to various embodiments of the present disclosure. As shown in FIG. 9, at 901, the base station transmits, to the terminal device, CSI resource information for determining at least one of frequency domain resources, power parameters and spatial parameters corresponding to channel state information (CSI); at 902, the base station transmits first information to the terminal device, herein the first information may be subband nonoverlapping duplex (SBFD) information or network energy saving information; at 903, the base station transmits indication information for indicating the terminal device to report the CSI feedback to the terminal device.

FIG. 10 illustrates a structure 1000 of a terminal device according to various embodiments of the present disclosure. As shown in FIG. 10, the terminal 1000 includes a controller 1010 and a transceiver 1020, herein the controller 1010 is configured to perform the methods described in FIG. 5 and FIG. 8 above, and the transceiver 1020 is configured to transmit and receive data or signals.

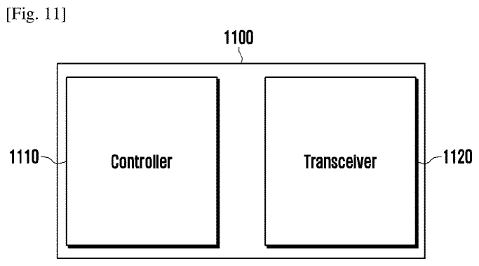

FIG. 11 illustrates a structure 1100 of a base station according to various embodiments of the present disclosure. As shown in FIG. 11, the base station 1100 includes a controller 1110 and a transceiver 1120, herein the controller 1110 is configured to perform the above-mentioned corresponding method disclosed herein, and the transceiver 1120 is configured to transmit and receive data or signal.

In this disclosure, the term “CSI resource information” is only used to refer to information indicating CSI resources, and is not limiting to the name, and may also be called “CSI resources indication information”, “CSI resource configuration information” and so on. Furthermore, the terms “CSI resources”, “measurement of CSI resources”, “CSI measurement resources”, “CSI resources for measurement” can be used interchangeably. The CSI feedback may also be referred to as a CSI report or CSI reporting.

It can also be understood that “at least one/at least one” described in this disclosure includes any and/or all possible combinations of listed items, various embodiments described in this disclosure and various examples in embodiments can be changed and combined in any suitable form.

The illustrative logical blocks, modules, and circuits described in this disclosure may be implemented in a general-purpose processor, a Digital Signal Processor (DSP), an application specific integrated circuit, ASIC), Field Programmable Gate Array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors cooperating with a DSP core, or any other such configuration.

The steps of a method or algorithm described in this disclosure may be embodied directly in hardware, in a software module performed by a processor, or in a combination of the both. Software modules may reside in RAM memory, flash memory, ROM memory, EPROM memory, EEPROM memory, registers, hard disks, removable disks, or any other form of storage media known in the art. An exemplary storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

In one or more exemplary designs, the described functions may be implemented in hardware, software, firmware, or any combination thereof. If implemented in software, each function can be stored on or transmitted by a computer-readable medium as one or more instructions or codes. Computer-readable media include both computer storage media and communication media, and the latter includes any media that facilitates the transfer of computer programs from one place to another. The storage medium can be any available medium that can be accessed by a general-purpose or special-purpose computer.

The description set forth herein, taken in conjunction with the drawings, describes example configurations, methods and devices, and does not represent all examples that can be realized or are within the scope of the claims. As used herein, the term “example” means “serving as an example, instance or illustration” rather than “preferred” or “superior to other examples”. The detailed description includes specific details in order to provide an understanding of the described technology. However, these techniques may be practiced without these specific details. In some cases, well-known structures and devices are shown in block diagram form to avoid obscuring the concepts of the described examples.

Although this specification contains many specific implementation details, these should not be interpreted as limitations on any invention or the scope of the claimed protection, but as descriptions of specific features of specific embodiments of specific inventions. Some features described in this specification in the context of separate embodiments can also be combined in a single embodiment. On the contrary, various features described in the context of a single embodiment can also be implemented separately in multiple embodiments or in any suitable sub-combination. Furthermore, although features may be described above as functioning in certain combinations, and even initially claimed as such, in some cases, one or more features from the claimed combination may be deleted from the combination, and the claimed combination may be directed to a subcombination or a variation of a subcombination.

It should be understood that the specific order or hierarchy of steps in the method of the present invention is illustrative of an exemplary process. Based on the design preference, it can be understood that the specific order or hierarchy of steps in the method can be rearranged to realize the functions and effects disclosed in the present invention. The appended method claims present elements of various steps in an example order, and are not meant to be limited to the particular order or hierarchy presented, unless otherwise specifically stated. Furthermore, although elements may be described or claimed in the singular, the plural is also contemplated unless the limitation on the singular is explicitly stated. Therefore, the present disclosure is not limited to the illustrated examples, and any means for performing the functions described herein are included in various aspects of the present disclosure.

Text and drawings are provided as examples only to help readers understand the present disclosure. They are not intended and should not be construed to limit the scope of the present disclosure in any way. Although certain embodiments and examples have been provided, based on the disclosure herein, it is obvious to those skilled in the art that changes can be made to the illustrated embodiments and examples without departing from the scope of this disclosure.

1-15. (canceled)

16. A method performed by a terminal in a communication system, the method comprising:
receiving, from a base station, configuration information on a channel state information (CSI) report;
identifying whether the terminal receives at least one channel state information reference signal (CSI-RS) transmission occasion of a CSI-RS resource in active periods of a cell discontinuous transmission (DTX) associated with a network energy saving;
in case that the terminal receives the at least one CSI-RS transmission occasion of the CSI-RS resource in the active periods of the DTX associated with the network energy saving, transmitting, to the base station, the CSI report; and
in case that the terminal does not receive the at least one CSI-RS transmission occasion of the CSI-RS resource, dropping the CSI report.

17. The method of claim 16, further comprising receiving, from the base station, information on the network energy saving.

18. The method of claim 16, wherein the configuration information includes information on CSI related quantities to report,
wherein the information on the CSI related quantities to report includes at least one rank indicator (RI), and
wherein the at least one CSI-RS transmission occasion of the CSI-RS resource is no later than a CSI reference resource.

19. The method of claim 16, wherein the at least one CSI-RS transmission occasion of the CSI-RS resource is for at least one of a channel measurement or an interference measurement, and
wherein the CSI-RS resource is associated with a time domain resource.

20. A method performed by a base station in a communication system, the method comprising:
transmitting, to a terminal, configuration information on a channel state information (CSI) report; and
in case that the base station transmits at least one channel state information reference signal (CSI-RS) transmission occasion of a CSI-RS resource in active periods of a cell discontinuous transmission (DTX) associated with a network energy saving, receiving, from the terminal, the CSI report,
wherein, in case that the base station does not transmit the at least one CSI-RS transmission occasion of the CSI-RS resource, the CSI report is dropped.

21. The method of claim 20, further comprising transmitting, to the terminal, information on the network energy saving.

22. The method of claim 20, wherein the at least one CSI-RS transmission occasion of the CSI-RS resource is for at least one of a channel measurement or an interference measurement, and
wherein the CSI-RS resource is associated with a time domain resource.

23. The method of claim 20, wherein the configuration information includes information on CSI related quantities to report,
wherein the information on the CSI related quantities to report includes at least one rank indicator (RI), and
wherein the at least one CSI-RS transmission occasion of the CSI-RS resource is no later than a CSI reference resource.

24. A terminal in a communication system, the terminal comprising:
a transceiver; and
at least one processor coupled with the transceiver and configured to:
receive, from a base station, configuration information on a channel state information (CSI) report,
identify whether the terminal receives at least one channel state information reference signal (CSI-RS) transmission occasion of a CSI-RS resource in active periods of a cell discontinuous transmission (DTX) associated with a network energy saving,
in case that the terminal receives the at least one CSI-RS transmission occasion of the CSI-RS resource in the active periods of the DTX associated with the network energy saving, transmit, to the base station, the CSI report, and
in case that the terminal does not receive the at least one CSI-RS transmission occasion of the CSI-RS resource, drop the CSI report.

25. The terminal of claim 24, wherein the at least one processor is further configured to receive, from the base station, information on the network energy saving.

26. The terminal of claim 24, wherein the configuration information includes information on CSI related quantities to report,
wherein the information on the CSI related quantities to report includes at least one rank indicator (RI), and
wherein the at least one CSI-RS transmission occasion of the CSI-RS resource is no later than a CSI reference resource.

27. The terminal of claim 24, wherein the at least one CSI-RS transmission occasion of the CSI-RS resource is for at least one of a channel measurement or an interference measurement, and
wherein the CSI-RS resource is associated with a time domain resource.

28. A base station in a communication system, the base station comprising:
a transceiver; and
at least one processor coupled with the transceiver and configured to:
transmit, to a terminal, configuration information on a channel state information (CSI) report, and
in case that the base station transmits at least one channel state information reference signal (CSI-RS) transmission occasion of a CSI-RS resource in active periods of a cell discontinuous transmission (DTX) associated with a network energy saving, receive, from the terminal, the CSI report,
wherein, in case that the base station does not transmit the at least one CSI-RS transmission occasion of the CSI-RS resource, the CSI report is dropped.

29. The base station of claim 28, wherein the at least one processor is further configured to transmit, to the terminal, information on the network energy saving.

30. The base station of claim 28, wherein the configuration information includes information on CSI related quantities to report,
wherein the information on the CSI related quantities to report includes at least one rank indicator (RI), and
wherein the at least one CSI-RS transmission occasion of the CSI-RS resource is no later than a CSI reference resource.

31. The base station of claim 28, wherein the at least one CSI-RS transmission occasion of the CSI-RS resource is for at least one of a channel measurement or an interference measurement, and
wherein the CSI-RS resource is associated with a time domain resource.
